(19) United States
(12) Patent Application Publication
(10) Pub. No.: US 2026/0100739 A1
(43) Pub. Date: Apr. 9, 2026

(54) SYSTEMS AND METHODS FOR ARTIFICIAL INFORMATION-BASED CHANNEL STATE INFORMATION REPORTING

(71) Applicant: Telefonaktiebolaget LM Ericsson (PUBL), Stockholm (SE)

(72) Inventors: Xinlin Zhang, VÄSTRA FRÖLUNDA (SE); Mattias Frenne, UPPSALA (SE); Jingya Li, GÖTEBORG (SE); Daniel Chen Larsson, LUND (SE)

(21) Appl. No.: 19/115,404

(22) PCT Filed: Sep. 27, 2023
(86) PCT No.: PCT/SE2023/050951

§ 371 Date: Mar. 26, 2025

Related U.S. Application Data
(60) Provisional application No. 63/411,958, filed on Sep. 30, 2022.

(51) Int. Cl. H04B 7/06; H04L 41/16

(52) U.S. Cl. CPC H04B 7/0626; H04L 41/16

(57) ABSTRACT

A method (700) by a user equipment, UE (112), for reporting Channel State Information, CSI, includes transmitting, to a network node (110), an Artificial Intelligence-based, AI-based, CSI report. The AI-based CSI report includes a plurality of parts. Each of the plurality of parts are transmitted on a respective one of a plurality of uplink control information, UCI, parts. An interpretation of at least one bit of at least one of the plurality of parts is based on an output of a machine learning model.

### TECHNICAL FIELD

The present disclosure relates, in general, to wireless communications and, more particularly, systems and methods for Artificial Information-based Channel State Information (CSI) reporting.

### BACKGROUND

The 5^{th} generation mobile wireless communication system, which is called New Radio (NR), uses Orthogonal Frequency Division Multiplexing (OFDM) with configurable bandwidths and subcarrier spacing to efficiently support a diverse set of use-cases and deployment scenarios. With respect to the 4^{th} generation system (LTE), NR improves deployment flexibility, user throughputs, latency, and reliability. The throughput performance gains are enabled, in part, by enhanced support for Multi-User Multiple Input Multiple Output (MU-MIMO) transmission strategies, where two or more User Equipment (UE) receives data on the same time frequency resources, i.e. spatially separated transmissions.

FIG. 1 illustrates the MU-MIMO transmission strategy. Specifically, FIG. 1 illustrates an example of a transmission and reception chain for MU-MIMO operations. Note the order of modulation and precoding, or demodulation and combining respectively, may differ depending on the implementation of MU-MIMO transmission.

A multi-antenna base station with N_{TX} antenna ports simultaneously (on the same OFDM time-frequency resources) transmits information to several UEs: the sequence S⁽¹⁾ is transmitted to UE(1), S⁽²⁾ is transmitted to UE(2), and so on. Before modulation and transmission, precoding

$${W}_{V}^{( j )}$$

is applied to each sequence to mitigate multiplexing interference, the transmissions are spatially separated.

Each UE demodulates its received signal and combines receiver antenna signals to obtain an estimate Ŝ⁽ⁱ⁾ of the transmitted sequence. This estimate Ŝ⁽ⁱ⁾ for UE(i) can be expressed as (neglecting other interference and noise sources except the MU-MIMO interference):

$${\hat{S}}^{{( i )}_{=}} \underbrace{{W}_{U}^{( i )} {H}^{( i )} {W}_{V}^{( i )}}_{\approx I} {S}^{( i )} + {W}_{U}^{( i )} {H}^{( i )} {\sum }_{j , j \neq i} {W}_{V}^{( j )} {S}^{( j )}$$

The second term represents the spatial multiplexing interference (due to MU-MIMO transmission) seen by UE(i). The goal for the Network (NW) is to construct the set of precoders

$$\{ {W}_{V}^{( j )} \}$$

to meet a given target. One such target is to make:
the norm

$$‖ {H}^{( i )} {W}_{V}^{( i )} ‖$$

large (this norm represents the desired channel gain towards UE(i); and
the norm

$$‖ {H}^{( j )} {W}_{V}^{( i )} ‖ , j \neq i$$

small (this norm represents the interference of UE(i)'s transmission received by UE(j)).

In other words, the precoder

$${W}_{V}^{( i )}$$

shall correlate well with the channel H⁽ⁱ⁾ observed by UE(i), whereas it shall correlate poorly with the channels observed by other UEs.

To construct precoders

$${W}_{V}^{( i )} ,$$

i=1, . . . , J that enable efficient MU-MIMO transmissions, the NW needs to obtain detailed information about all the users downlink channels H(i), i=1, . . . , J.

In deployments where full channel reciprocity holds, detailed channel information can be obtained from uplink sounding reference signals (SRS) that are transmitted periodically, or on demand, by active UEs. The NW can directly estimate the uplink channel from SRS and, therefore (by reciprocity), the downlink channel H⁽ⁱ⁾.

However, the NW cannot always accurately estimate the downlink channel from uplink reference signals. Consider the following examples:
In frequency division duplex (FDD) deployments, the uplink and downlink channels use different carriers and, therefore, the uplink channel might not provide enough information about the downlink channel to enable MU-MIMO precoding.
In time division duplex (TDD), the NW might only estimate part of the uplink channel using sounding reference signal (SRS), because the UE typically has fewer transmitter/transmission (TX) branches than receiver/reception (RX) branches (in which case only certain columns of the precoding matrix can be estimated using SRS). This is known as partial channel knowledge.

If the NW cannot accurately estimate the full downlink channel from uplink transmissions, active UEs need to report channel information to the NW over the uplink. In LTE and NR, this feedback is achieved by the following signalling protocol:
The NW periodically transmits Channel State Information-Reference Signals (CSI-RS) over the downlink using N ports.
The UE estimates the downlink channel for each of the N ports from the transmitted CSI-RS.
The UE reports CSI (e.g., Channel Quality Information (CQI), Precoder Matrix Indicator (PMI), and Rank Indicator (RI), where PMI is the precoder and RI is the rank of the precoder) to the NW over uplink (control or data) channel.
The NW uses the UE's feedback to select suitable precoders for downlink MU-MIMO transmissions.

In NR, both Type I and Type II reporting is configurable, where the CSI Type II reporting protocol has been specifically designed to enable MU-MIMO operations from uplink UE reports.

The CSI Type II normal reporting mode is based on the specification of sets of Discrete Fourier Transform (DFT) basis functions in a precoder codebook. The UE selects and reports the L DFT vectors from the codebook that best match its channel conditions (like the classical codebook PMI from earlier 3^{rd} Generation Partnership Project (3GPP) releases). The number of DFT vectors L is typically 2 or 4 and is configurable by the NW. In addition, the UE reports how the L DFT vectors should be combined in terms of relative amplitude scaling and co-phasing.

Algorithms to select L, the L DFT vectors, and co-phasing coefficients are outside the scope of 3GPP specification and, thus, are left to UE and NW implementation. Put another way, the Release 16 specification only defines signalling protocols to enable the above message exchanges.

Herein, the terms “DFT beams” and “DFT vectors” are used interchangeably. While this may be considered a slight abuse of terminology, such use may be considered appropriate whenever the base station has a uniform planar array with antenna elements separated by half of the carrier wavelength.

FIG. 2 illustrates CSI type II feedback for CSI type II normal reporting mode. See 3GPP TS 38.214, Physical layer procedures for data, V160.0. The selection and reporting of the L DFT vectors bₙ and their relative amplitudes aₙ is done in a wideband manner; that is, the same beams are used for both polarizations over the entire transmission band. The selection and reporting of the DFT vector co-phasing coefficients is done in a subband manner; that is, DFT vector co-phasing parameters are determined for each of multiple subsets of contiguous subcarriers. The co-phasing parameters are quantized such that e^{jθ}^{ₙ} is taken from either a Quadrature Phase Shift Keying (QPSK) or Eight Phase Shift Keying (8PSK) signal constellation.

With k denoting a sub-band index, the precoder W_{V}[k] reported by the UE to the NW can be expressed as follows:

$${W}_{V} [ k ] = {\sum }_{n} {b}_{n} {a}_{n} {e}^{j {θ}_{n} [ k ]} .$$

The Type II CSI report can be used by the NW to co-schedule multiple UEs on the same OFDM time-frequency resources. For example, the NW can select UEs that have reported different sets of DFT vectors with weak correlations. The CSI Type II report enables the UE to report a precoder hypothesis that trades CSI resolution against uplink transmission overhead.

NR 3GPP Release 15 supports Type II CSI feedback using port selection mode, in addition to the above normal reporting mode. In this case,
The base station transmits a CSI-RS port in each one of the beam directions.
The UE does not use a codebook to select a DFT vector (a beam), instead the UE selects one or multiple antenna ports from the CSI-RS resource of multiple ports.

Type II CSI feedback using port selection gives the base station some flexibility to use non-standardized precoders that are transparent to the UE. For the port-selection codebook, the precoder reported by the UE can be described as follows (excluding eventual normalization):

$${W}_{V} [ k ] = {\sum }_{n} {e}_{n} {a}_{n} {e}^{j {θ}_{n} [ k ]}$$

Here, the vector e is a unit vector with only one non-zero element, which can be viewed as a selection vector that selects a port from the set of ports in the measured CSI-RS resource. The UE thus feeds back which ports it has selected, the amplitude factors and the co-phasing factors.

### CSI Reporting in NR

In NR, a UE can be configured with one or multiple CSI Report Settings, and each CSI Report Setting can be configured by a higher layer parameter CSI-ReportConfig. Each CSI-ReportConfig is associated with a bandwidth part (BWP) and contains one or more of the following:
a CSI resource configuration for channel measurement;
a CSI-Inference Management (CSI-IM) resource configuration for interference measurement;
reporting configuration type (i.e., aperiodic CSI (on Physical Uplink Shared Channel (PUSCH)), periodic CSI (on Physical Uplink Control Channel (PUCCH)), or semi-persistent CSI on PUCCH or PUSCH);
report quantity specifying what to be reported, such as RI, PMI, CQI;
codebook configuration such as type I or type IT CSI;
frequency domain configuration (i.e., subband vs. wideband CQI or PMI, and subband size); and
CQI table to be used.

A UE can be configured with one or multiple CSI resource configurations for channel measurement and one or more CSI-IM resources for interference measurement. Each CSI resource configuration for channel measurement can contain one or more Non Zero Power (NZP) CSI-RS resource sets. For each NZP CSI-RS resource set, it can further contain one or more NZP CSI-RS resources. A NZP CSI-RS resource can be periodic, semi-persistent, or aperiodic.

Similarly, each CSI-IM resource configuration for interference measurement can contain one or more CSI-IM resource sets. For each CSI-IM resource set, it can further contain one or more CSI-IM resources. A CSI-IM resource can be periodic, semi-persistent, or aperiodic.

### Type H CSI Report on PUSCH

A UE shall perform aperiodic CSI reporting using PUSCH upon successful decoding of a DCI format 0_1 or DCI format 0_2, which triggers an aperiodic CSI trigger state.

When a DCI format 0_1 schedules two PUSCH allocations, the aperiodic CSI report is carried on the second scheduled PUSCH. When a DCI format 0_1 schedules more than two PUSCH allocations, the aperiodic CSI report is carried on the penultimate scheduled PUSCH.

A UE shall perform semi-persistent CSI reporting on the PUSCH upon successful decoding of a DCI format 0_1 or DCI format 0_2, which activates a semi-persistent CSI trigger state. DCI format 0_1 and DCI format 0_2 contains a CSI request field, which indicates the semi-persistent CSI trigger state to activate or deactivate. The PUSCH resources and Modulation and Coding Scheme (MCS) shall be allocated semi-persistently by an uplink DCI.

CSI reporting on PUSCH can be multiplexed with uplink data on PUSCH. CSI reporting on PUSCH can also be performed without any multiplexing with uplink data from the UE.

Part 1 and Part 2 for Type II CSI report

For the Release 15 Type II and the Release 16 Type II (aka Enhanced Type II, or eType II) CSI feedback on PUSCH, a CSI report comprises of two parts: Part 1 and Part 2. A main motivation for dividing a CSI report into Part 1 and Part 2 is to deal with the dynamically varying CSI payload. For example, based on the time-varying channel, UE may report different ranks over the whole period of connection, which has significant impact on the actual required CSI payload size. In order for the gNodeB (gNB) to know the actual payload size, Part 1, which has a fixed payload size that carries the information to calculate the payload size of Part 2, will be decoded first by the gNB.

For the Release 15 Type II CSI feedback, Part 1 contains RI (if reported), CQI, and an indication of the number of non-zero wideband amplitude coefficients per layer for the Type II CSI. See, 3GPP TS 38.214, Clause 5.2.2.2.3. The fields of Part 1—RI (if reported), CQI, and the indication of the number of non-zero wideband amplitude coefficients for each layer—are separately encoded. Part 2 contains the PMI of the Type II CSI. Part 1 and 2 are separately encoded.

For the Release 16 Type II CSI feedback, Part 1 contains RI, CQI, and an indication of the overall number of non-zero amplitude coefficients across layers for the Release 16 Type II CSI. See, 3GPP TS 38.214, Clause 5.2.2.2.5. The fields of Part 1—RI, CQI, and the indication of the overall number of non-zero amplitude coefficients across layers—are separately encoded. Part 2 contains the PMI of the Enhanced Type II CSI. Part 1 and 2 are separately encoded.

### UCI Omission Procedure for Type II CSI Report

Due to the fact that there can be a large discrepancy between the PMI payload for different selection of RI by the UE for Type II CSI reporting, it is possible that the PUSCH resource allocation for carrying the CSI report does not fit the entire CSI content. For instance, the rank-2 PMI payload is almost 2× the rank-1 PMI payload for the Release 15/Release 16 Type II codebook. Since the RI is dynamically selected by the UE, the gNB cannot entirely predict the PMI payload before scheduling the CSI report and, hence, the resource allocation may be too small. That is, the gNB may have scheduled a resource appropriate for a rank-1 PMI report (due to, for example, that the UE lately have been reporting RI=1) but the UE reports rank-2 PMI, which will not fit in the allocated PUSCH resource.

To remedy this case, CSI omission procedures have been specified in 3GPP. According to these procedures, a portion of CSI Part 2 can be omitted if the resulting UCI code rate is too low (Part 1 cannot be omitted as it is needed to correctly decode Part 2). This is achieved by segmenting the CSI Part 2 payload into different priority levels, and dropping CSI segment starting with the lowest priority level until the UCI code rate falls below a threshold (whereby the CSI payload will “fit” on the PUSCH allocation. The priority levels for both Release 15 and Release 16 Type II are described in Table 1Table 1 below, which corresponds to Table 5.2.3-1 in 3GPP TS 38.214 V16.0.0, where Priority 0 has the highest priority and N_{Rep} represents the number of CSI reports. The CSI omission procedure is explained in more details below.

TABLE 1
Priority reporting levels for Part 2 CSI

Priority 0:
For CSI reports 1 to N_{Rep}, Group 0 CSI for CSI reports
configured as ‘typeII-r16’ or ‘typeII-PortSelection-r16’;
Part 2 wideband CSI for CSI reports configured
otherwise
Priority 1:
Group 1 CSI for CSI report 1, if configured as ‘typeII-
r16’ or ‘typeII-PortSelection-r16’; Part 2 subband CSI of
even subbands for CSI report 1, if configured otherwise
Priority 2:
Group 2 CSI for CSI report 1, if configured as ‘typeII-
r16’ or ‘typeII-PortSelection-r16’; Part 2 subband CSI of
odd subbands for CSI report 1, if configured otherwise
Priority 3:
Group 1 CSI for CSI report 2, if configured as ‘typeII-
r16’ or ‘typeII-PortSelection-r16’; Part 2 subband CSI of
even subbands for CSI report 2, if configured otherwise
Priority 4:
Group 2 CSI for CSI report 2, if configured as ‘typeII-
r16’ or ‘typeII-PortSelection-r16’. Part 2 subband CSI of
odd subbands for CSI report 2, if configured otherwise
.
.
.
Priority 2N_{Rep} − 1:
Group 1 CSI for CSI report N_{Rep}, if configured as
‘typeII-r16’ or ‘typeII-PortSelection-r16’; Part 2 subband
CSI of even subbands for CSI report N_{Rep}, if configured
otherwise
Priority 2N_{Rep}:
Group 2 CSI for CSI report N_{Rep}, if configured as
‘typeII-r16’ or ‘typeII-PortSelection-r16’; Part 2 subband
CSI of odd subbands for CSI report N_{Rep}, if configured
otherwise

### Release 15 Type II CSI Omission

For Release 15 Type II, CSI Part 2 is divided into a wideband PMI part and a subband PMI part. The wideband part carries information such as spatial domain (SD) basis indication including rotation factor (for regular Type II) or port indication (for port-selection Type II), wideband amplitude coefficients per layer and strongest coefficient indicator (SCI) per layer. The subband part carries information such as subband amplitude and phase.

The subband PMI is the most payload heavy since it is reported independently for each subband (whereas the wideband PMI is only reported once for the entire CSI reporting band). In the described CSI omission procedure, subband PMI for odd and even numbered subbands are respectively grouped into different CSI segments with different priority. This implies that if the PUSCH resource allocation is too small to fit the CSI payload, the subband PMI for the odd subbands can be dropped and only subband PMI for even subbands are reported.

The motivation behind this design is that the reported remaining PMI can still be used by the gNB. Since the gNB has knowledge of the subband PMI for every other subband, it can perform interpolation between subbands to estimate the PMI for the omitted subbands. Due to that the subband PMIs are correlated in frequency, the performance loss may not be that severe.

### Release 16 Type II CSI Omission

For Release 16 Type II, CSI Part 2 is segmented into three groups:
Group 0: SD basis indication including rotation factor (for Release 16 regular Type II) or port indication (for Release 16 port-selection Type II), SCI for each layer.
Group 1: Frequency Domain (FD) basis indication for each layer, wideband (polarization) reference amplitude, part of the bitmap and amplitude and phase for subband coefficients with the highest priority.
Group 2: The remaining part of bitmap and amplitude and phase for subband coefficients with the lowest priority.

For each reported element of bitmap, subband amplitude and phase in Group 1 and 2, a priority level is determined via the value of the following priority function, indexed by l, i, f:

$$Pri ( l , i , f ) = 2 \cdot L \cdot v \cdot π ( f ) + v \cdot i + l ,$$

with

$$π ( f ) = min ( 2 \cdot {n}_{3 , l}^{( f )} , 2 \cdot ( {N}_{3} - {n}_{3 , l}^{( f )} ) - 1 )$$

with l=1, 2, . . . , υ being the layer index and v being the RI, i=0, 1, . . . , 2L−1 being the index of selected ports, f=0,1, . . . , M_{υ}−1 being the index of selected FD basis vectors and Mᵥ being the number of selected FD basis vectors for each layer, and

$${n}_{3 , l}^{( f )} ∈ \{ 0 , 1 , … , {N}_{3} - 1 \}$$

being the index of FD basis vectors from which the UE can select, and N₃ is the number of PMI subbands. The element with the highest priority has the lowest associated value Pri(l, i, f).

The motivation behind the way grouping is done is that gNB should still be able to recover part of the CSI even if some low priority groups are omitted. For example, if Group 1 and 2 are omitted, the PMI feedback in Group 0 is essentially a Type I PMI, gNB can still schedule Single User-MIMO (SU-MIMO) based on that CSI report. In another example, if Group 2 is omitted, information of selected SD and FD basis vectors is still complete, it's only part of the combination coefficients that are omitted. However, since the combination coefficients are reported and omitted in a predictable manner based on the pre-defined priority function, gNB is still aware of the association between the reported coefficients and the SD and FD basis vector. Thus, downlink (DL) channel can still be partly obtained via the incomplete CSI report.

### Autoencoders for AI/ML-Enhanced CSI Reporting

Recently neural network based autoencoders (AEs) have shown promising results for compressing downlink MIMO channel estimates for uplink feedback. For example:
Reference [3] provides a recent summary of academic work.
Certain previous techniques use AEs to improve the accuracy of reported CSI from the UE to the NW.
Certain contributions to the June 2021 3GPP TSG RAN Release 18 Workshop all support studying AI/ML-enhanced CSI reporting in a potential Release 18 “AI/ML on PHY” study item.

An AE is a type of artificial neural network (NN) that can be used to compress and decompress data, in an unsupervised manner, often with high fidelity.

FIG. 3 illustrates a simple fully connected (dense) AE. The AE is divided into two parts:
an encoder (used to compress the input data X), and
a decoder (used to de-compress the input data).

AEs can have different architectures. For example, AEs can be based on dense NNs, multi-dimensional convolution NNs, variational, recurrent NNs, transformer networks, or any combination thereof. However, all AE architectures possess an encoder-bottleneck-decoder structure illustrated in FIG. 3.

The size of the codeword (denoted by Y in FIG. 3) of an AE is typically a lot smaller than the size of the input data (X in FIG. 3). The AE encoder thus reduces the dimensionality of the input features X down to Y. The decoder part of the AE tries to invert the encoder and reconstruct X with minimal error, according to some predefined loss function.

FIG. 4 illustrates how an AE might be used for CSI compression for AI/Machine Learning (ML)-enhanced CSI reporting in NR. The UE measures the channel in the downlink using CSI-RS. The UE estimates that channel for each subcarrier (sc) from each base station TX antenna and at each UE RX antenna. The estimate can be viewed as a three-dimensional channel matrix. The 3D channel matrix represents the MIMO channel estimated over several subcarriers (sc) and is input to the encoder.

The AE encoder is implemented in the UE, and the AE decoder is implemented in the NW. The output of the AE encoder is signalled from the UE to the NW over the uplink. The codeword can be viewed a learned latent representation of the channel. Note that a quantization layer may be connected at the output of the encoder or directly included in the encoder, so that the codeword consists of quantized values that are transmitted to the gNB in a CSI report.

The architecture of an AE (e.g., number of layers, nodes per layer, activation function, etc.) typically needs to be numerically optimized for CSI reporting via a process called hyperparameter tuning. Properties of the data (e.g., CSI-RS channel estimates), the channel size, uplink feedback rate, and hardware limitations of the encoder and decoder all need to be considered when optimizing the AE's architecture.

The weights and biases of an AE (with a fixed architecture) are trained to minimize the reconstruction error (the error between the input X and output \hat{X}) on some training dataset. For example, the weights and biases can be trained to minimize the mean squared error (MSE) (X− [symbol] . Model training is typically done using some variant of the gradient descent algorithm on a large training data set. To achieve good performance during live operation, the training data set should be representative of the actual data the AE will encounter during live operation.

The process of designing an AE (hyperparameter tuning and model training) can be expensive, consuming significant time, compute, memory, and power resources.

CAICT and OPPO's 3GPP contribution to the June 2021 RAN Release 18 Workshop summarizes a recent competition to design and train AEs specifically for CSI reporting in 3GPP networks. See, RWS-210236, Introduction of the 1st Wireless communication AI competition (WAIC), CAICT, OPPO, TSG RAN Rel-18 workshop, Jun. 28- Jul. 2, 2021. It was claimed that the competition involved more than 900 teams, comprised of 1175 contestants from 210 companies. The winning AE used a transformer based network to compress a 24,576 bit “raw” channel representation down to 286 bits at the UE (for uplink feedback), while still allowing the NW to reconstruct with a normalized mean square error of 0.1 or less.

### Autoencoders for CSI Reporting

AE-based CSI reporting is of interest for 3GPP Rel 18 “AI/ML on PHY” study item because of the following reasons:
AEs can include non-linear transformations (e.g., activation functions) that help improve compression performance and, therefore, MU-MIMO performance for the same uplink overhead. For example, the normal Type II CSI codebooks in 3GPP Release 16 are based on linear DFT transformations and Singular Value Decomposition (SVD), which cannot fully exploit redundancies in the channel for compression.
AEs can be trained to exploit long-term redundancies in the propagation environment and/or site (e.g., antenna configuration) for compression purposes. For example, a particular AE does not need to work well for all possible deployments. Improved compression performance is obtained by learning which channel inputs it needs to (and doesn't need to) reliably reconstruct at the base-station.
AEs can be trained to compensate for antenna array irregularities, including, for example, non-uniformly spaced antenna elements and non-half wavelength element spacing. The Type II CSI codebooks in Release 15 and 16, for example, use a two-dimensional DFT codebook designed for a regular planar array with perfect half wavelength element spacing.
AEs can be trained so that the used CSI reporting is more robust against or updated (e.g., via transfer learning and training) to compensate for partially failing hardware as the massive MIMO product ages. For example, over time one or more of the multiple Tx and Rx radio chains in the massive MIMO antenna arrays at the base station will fail compromising the effectiveness of Type II CSI feedback.

### A General Architecture for a Hybrid Model-Learning Based CSI Compression

FIG. 5 illustrates a general architecture for the configuration for the proposed hybrid approach for CSI compression and reporting scheme, which comprises a model-based dimension-reduction step and an AE-based learned compression step.

The UE estimates the downlink channel based on the configured downlink reference signals (e.g., CSI-RS, DMRS, etc.) and produces a channel estimate, H, for example, in the antenna-frequency domain.

The raw channel H can be expressed per CSI-RS port (TX side), per receive antenna (RX side), per frequency subband, and measured at one or more points in time. Hence, in the most general cases, the channel H is a four-dimensional matrix or tensor.

The raw channel estimate H is further processed in the UE using a model-based method, through a function H_{model}=f(H) where f(⋅) defines the processing performed in the model-based unit, which aims to extract certain coarse features of the channel which are most relevant information for the base station in order to perform precoding and transmission in the downlink to the UE.

Such features can be, for example, the number of and direction/angle of dominant propagation paths (e.g., those with the largest energy/lowest propagation loss) and possibly also the delay information associated with each of these dominant paths. The extracted features are encoded into bits (e.g., denoted as b_{model}) and reported to the gNB, as part of the uplink CSI report. After feature extraction, a compressed channel H_{model} is also produced.

In general, H_{model} may have reduced dimension compared to the raw channel estimate H. However, this does not need to always hold, in some cases, the model-based dimension reduction step can maintain the dimension of H, while only transforming the channel to another domain where the transformed channel, H_{model}, is easier for the AE to compress. Such example could be to transform the channel from antenna-frequency domain to beam-delay domain where the channel representation is sparser. Another example would be to transform the channel from antenna-frequency-time domain to beam-delay-doppler domain.

The output from the model-based dimension reduction step, H_{model}, is then fed into the AE-encoder for further compression. Another set of features, e.g., fine details of the channel, will be extracted in this step, such feature can be, for example, small-scale fading channel coefficients, and eigen-vectors and values of the channel. The extracted features (excluding information that are encoded by the AE encoder step) are encoded into bits (e.g., denoted as b_{AE})) and to be reported to gNB, as part of the uplink CSI report.

Note that the above general architecture can also be applied for CSI/channel prediction. For example, the channel measurement H might be obtained by measuring multiple CSI-RS resources over a period of time, and the model-based feature extraction step can be used to extract time-domain (or equivalently Doppler-domain) basis for representing the channel, while the AE-based feature extraction (which for example could contain some feedback connections, e.g., an long short-term memory (LSTM) neural network) can be used to obtain some form of compressed channel/CSI representation in the angle/delay/doppler domain. Then, at the gNB side, the gNB can obtain the required CSI for the current and/or a future time based the received CSI reports.

Note also that some auxiliary information, e.g., a bit sequence b_{AUX}, may be transmitted in a CSI report to help decode b_{model} and b_{AE}. For example, b_{AUX} could help determine the size/bitwidth of b_{model}, e.g., by reporting the number of SD/FD/TD basis vectors that have been selected, or b_{AUX} could help determine the size/bitwidth of b_{AE}, by reporting some AI/ML model identifier (ID), etc. In this case, b_{AUX} may be generated from either at the model-based processing step or the AE-based processing step.

There currently exist certain challenges, however. For example, AI-based CSI report will be studied and specified in 3GPP Release18, and it is a problem to define what to report and how to report such kind of CSI report.

### SUMMARY

Certain aspects of the disclosure and their embodiments may provide solutions to these or other challenges. For example, methods and systems are provided for reporting AI-based CSI on UCI. Certain embodiments include segmentation of the CSI report and/or mapping order of CSI report to UCI bit sequences.

According to certain embodiments, a method by a UE for reporting CSI includes transmitting, to a network node, an AI-based CSI report that comprises a plurality of parts. Each of the plurality of parts are transmitted on a respective one of a plurality of UCI parts. An interpretation of at least one bit of at least one of the plurality of parts is based on an output of a machine learning model.

According to certain embodiments, a UE for reporting CSI is adapted to transmit, to a network node, an AI-based CSI report that comprises a plurality of parts. Each of the plurality of parts are transmitted on a respective one of a plurality of UCI parts. An interpretation of at least one bit of at least one of the plurality of parts is based on an output of a machine learning model.

According to certain embodiments, a method by a network node for receiving reported CSI includes receiving, from a UE, an AI-based CSI report that comprises a plurality of parts. Each of the plurality of parts are received on a respective one of a plurality of UCI parts. An interpretation of at least one bit of at least one of the plurality of parts is based on an output of a machine learning model.

According to certain embodiments, a network node for receiving reported CSI is adapted to receive, from a UE, an AI-based CSI report that comprises a plurality of parts. Each of the plurality of parts are received on a respective one of a plurality of UCI parts. An interpretation of at least one bit of at least one of the plurality of parts is based on an output of a machine learning model.

Certain embodiments may provide one or more of the following technical advantages. For example, certain embodiments may provide a technical advantage of providing a solution to the AI-based CSI reporting that is also robust with respect to dynamically varying channel(s) and, thus, payload size.

Other advantages may be readily apparent to one having skill in the art. Certain embodiments may have none, some, or all of the recited advantages.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 illustrates the MU-MIMO transmission strategy;

FIG. 2 illustrates CSI type II feedback for CSI type II normal reporting mode;

FIG. 3 illustrates a simple fully connected (dense) AE;

FIG. 4 illustrates how an AE might be used for CSI compression for AI/Machine Learning (ML)-enhanced CSI reporting in NR;

FIG. 5 illustrates a general architecture for the configuration for the proposed hybrid approach for CSI compression and reporting scheme, which comprises a model-based dimension-reduction step and an AE-based learned compression step;

FIG. 6 illustrates an example communication system, according to certain embodiments;

FIG. 7 illustrates an example UE, according to certain embodiments;

FIG. 8 illustrates an example network node, according to certain embodiments;

FIG. 9 illustrates a block diagram of a host, according to certain embodiments;

FIG. 10 illustrates a virtualization environment in which functions implemented by some embodiments may be virtualized, according to certain embodiments;

FIG. 11 illustrates a host communicating via a network node with a UE over a partially wireless connection, according to certain embodiments;

FIG. 12 illustrates a method by a UE for reporting CSI, according to certain embodiments; and

FIG. 13 illustrates a method by a network node for receiving reported CSI, according to certain embodiments.

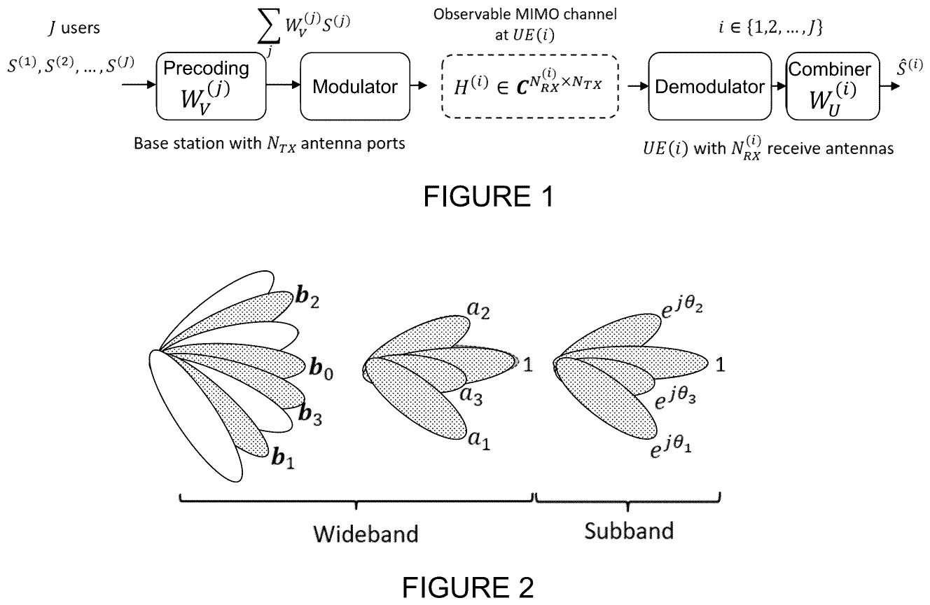

### DETAILED DESCRIPTION

Some of the embodiments contemplated herein will now be described more fully with reference to the accompanying drawings. Embodiments are provided by way of example to convey the scope of the subject matter to those skilled in the art.

As used herein, ‘node’ can be a network node or a UE. Examples of network nodes are NodeB, base station (BS), multi-standard radio (MSR) radio node such as MSR BS, eNodeB (eNB), gNodeB (gNB), Master eNB (MeNB), Secondary eNB (SeNB), integrated access backhaul (IAB) node, network controller, radio network controller (RNC), base station controller (BSC), relay, donor node controlling relay, base transceiver station (BTS), Central Unit (e.g., in a gNB), Distributed Unit (e.g., in a gNB), Baseband Unit, Centralized Baseband, C-RAN, access point (AP), transmission points, transmission nodes, Remote Radio Unit (RRU), Remote Radio Head (RRH), nodes in distributed antenna system (DAS), core network node (e.g., Mobile Switching Center (MSC), Mobility Management Entity (MME), etc.), Operations & Maintenance (O&M), Operations Support System (OSS), Self Organizing Network (SON), positioning node (e.g., E-SMLC), etc.

Another example of anode is user equipment (UE), which is anon-limiting term and refers to any type of wireless device communicating with a network node and/or with another UE in a cellular or mobile communication system. Examples of UE are target device, device to device (D2D) UE, vehicular to vehicular (V2V), machine type UE, Machine Type Communications (MTC) UE or UE capable of machine to machine (M2M) communication, Personal Digital Assistant (PDA), Tablet, mobile terminals, smart phone, laptop embedded equipment (LEE), laptop mounted equipment (LME), Unified Serial Bus (USB) dongles, etc.

In some embodiments, generic terminology, “radio network node” or simply “network node (NW node)”, is used. It can be any kind of network node which may comprise BS, radio BS, base transceiver station, base station controller, network controller, evolved Node B (eNB), Node B, gNodeB (gNB), relay node, access point, radio access point, Remote Radio Unit (RRU) Remote Radio Head (RRH), Central Unit (e.g., in a gNB), Distributed Unit (e.g., in a gNB), Baseband Unit, Centralized Baseband, C-RAN, access point (AP), etc.

The term radio access technology (RAT), may refer to any RAT such as, for example, Universal Terrestrial Radio Access Network (UTRA), Evolved Universal Terrestrial Radio Access Network (E-UTRA), narrow band internet of things (NB-IoT), WiFi, Bluetooth, next generation Radio Access Technology (RAT), NR, 4G, 5G, etc. Any of the equipment denoted by the terms node, network node or radio network node may be capable of supporting a single or multiple RATs.

A standardized format of CSI report (e.g., what to report, and how to report) is essential so that the UE can efficiently compress and report the CSI, and then the gNB can correctly retrieve the CSI according the reported CSI. In 3GPP NR Release 18, AI-based CSI compression/reporting will be studied and specified.

As discussed above, FIG. 5 illustrates a general architecture of hybrid model-learning CSI compression. In this general architecture, the CSI compression and decompression consist of a model-based processing step and an AI-based (e.g., using AE) processing step. However, note that this general architecture is flexible, in a sense that the model-based processing step can be optional. In that case, only the AE-based compression and decompression parts remain.

According to certain embodiments, solutions and techniques are disclosed that include detailed reporting mechanisms such as, for example, what quantities to report and how to report the information, for hybrid model-learning CSI compression.

For example, according to certain embodiments, a method performed by a UE, for reporting a CSI report on UCI when being configured with an AI-based CSI reporting, includes one or multiple of the following:
Segmenting of the complete CSI report into multiple parts, which are transmitted on different parts of the UCI;
   Determining of the content (i.e., binary bits) for each part of the CSI;
   Determining the priority level associated with each bit or bit-group that are candidates for CSI omission.

In a particular embodiment, the CSI report is segmented into Part 1 CSI and Part 2 CSI.

In a particular embodiment, the CSI report only contains Part 2 CSI.

In a particular embodiment, the CSI report is segmented into Part 1 CSI, Part 2 CSI, and a newly defined part of CSI for AI-CSI reporting (e.g., Part 3 CSI, or AI CSI).

In a particular embodiment, the CSI report is segmented in to Part 1 CSI, and a newly defined part of CSI for AI-CSI reporting (e.g., Part 3 CSI, or AI CSI).

In a particular embodiment, the CSI report only contains a newly defined part of CSI for AI-CSI reporting (e.g., Part 3 CSI, or AI CSI).

In a particular embodiment, the newly defined part of CSI for AI-CSI reporting (e.g., Part 3 CSI, or AI CSI) contains multiple sub parts.

In a particular embodiment, one or multiple of the followings are included in Part 1 CSI, if reported:
Any of the legacy CSI report quantities, e.g., CRI, RI, CQI, etc.
Any of auxiliary information that helps to decode Part 2 CSI and/or the newly defined part of CSI for AI-CSI.

In a particular embodiment, the features/CSI extracted from the AE-based processing step are transmitted on Part 2 CSI and/or a newly defined part of CSI for AI-CSI reporting (e.g., Part 3 CSI, or AI CSI).

In a further particular embodiment, the number of reported bits representing the features/CSI extracted from the AE-based processing step, is known to the gNB.

In a further particular embodiment, the said number of bits is configured explicitly by the gNB.

In a particular embodiment, the said number of bits is reported explicitly by the UE.

In a particular embodiment, the said number of bits can be inferred by the gNB according to other dependent parts of the CSI report, e.g., some auxiliary information.

In a particular embodiment, the reported bits representing the features/CSI extracted from the AE-based processing step are reported according to a standardized ordering.

In a particular embodiment, the reported bits representing the features/CSI extracted from the AE-based processing step are reported according to an implicit ordering which has been obtained through joint training of the encoder and decoder.

In a particular embodiment, the bit sequence is further segmented into multiple parts/groups.

In a further particular embodiment, the segmentation is based on one or multiple of the following:
A subset of nodes from the output layer of the AE;
Transmission layer;
Spatial domain information provided by the CSI;
Frequency domain information provided by the CSI;
Time domain information provided by the CSI.
A pre-defined priority function.

In a further particular embodiment, the priority function depends on one or multiple of the following:
Transmission layer index;
CSI-RS or antenna port index;
Basis index of some kind (e.g., spatial/frequency/time domain basis);
AI/ML model index;
Node index of an AI/ML model;
Index for the type of CSI report;
CSI report index.

### General CSI Reporting Framework

According to certain embodiments, for AI-based CSI reporting under hybrid model-learning compression, the CSI report can be segmented and reported in multiple parts. For example, some segments can be reported in Part 1 CSI, some other segments can be reported in Part 2 CSI, and/or some newly defined type of CSI segments (e.g., Part 3 CSI, or AI CSI) can be reported.

In a particular embodiment, there can be common report quantities for the AI-based CSI and the legacy CSI (e.g., Type I/II), such as CRI, RI, CQI. It is reasonable to report such quantities as in the legacy reporting such as, for example, in Part 1 CSI. However, new methods and techniques are disclosed herein for reporting quantities that are unique for the AI-based CSI compression.

In a particular embodiment, the CSI reports carried on Part 1, Part 2, and possibly any newly defined type of CSI segments (e.g., Part 3 CSI, or AI CSI) are part of the uplink control information (UCI), which can either be carried on PUCCH or PUSCH.

In a particular embodiment, the newly defined type of CSI for AI-CSI may further comprise multiple sub parts/segments.

In a particular embodiment, the compressed CSI could either be a PMI or an explicit channel.

Reporting of Channel Features Extracted from the Model-Based Processing Step

In a particular embodiment, the model-based processing step can be used as a way to pre-process the channel before feeding it to the AI-based CSI compression module (e.g., the encoder of an AE). In general, coarse channel features (large-scale channel information) such as, for example, CSI that is related to the dominant directions, dominant delays, dominant doppler components of the channel, can be extracted and reported to the gNB via, for example, b_{model} in FIG. 5. By correctly decoding b_{model}, the gNB can retrieve the extracted coarse channel features which then can be used for obtaining the downlink CSI and then for downlink precoding, scheduling, etc.

In a particular embodiment, dominant directions of the channel are extracted in the model-based processing step and reported. The reported dominant directions can be represented by the indices of selected DFT basis vectors, where each DFT basis vector corresponds to a 1-dimentional (1D) or 2-dimentional (2D) beam that points to a certain spatial direction when applied to a 1D or 2D (uniform) antenna array. Furthermore, in a further particular embodiment, the DFT basis vectors may be oversampled, then the selected oversampling factor is also reported. In yet another particular embodiment, the number of dominant directions of the channel is also reported.

In a particular embodiment, dominant delays of the channel is extracted in the model-based processing step and reported. The reported dominant delays can be represented by the indices of selected DFT basis vectors, where the dimension of the DFT basis vector is the same as the number of PMI subbands. Thus, each DFT basis vector corresponds to a quantized delay value. In further particular embodiment, the DFT basis vectors may be oversampled, then the selected oversampling factor is also reported. In yet another particular embodiment, the number of dominant delays of the channel is also reported.

In a particular embodiment, the dominant Doppler component of the channel is extracted in the model-based processing step and reported. The dominant Doppler component can be used to describe the time-domain channel property of the channel. The dominant Doppler component can, for example, be represented/approximated by a number of selected basis vectors (e.g., Bessel function of zero-th order or DFT).

In another particular embodiment, CSI-RS ports are beamformed and the UE is configured to select a subset of CSI-RS ports. In this case, the UE can report the select ports using combinatorial coefficients.

In yet another particular embodiment, eigenvectors of the propagation channel, or channel covariance matrix of some form, can be extracted from the model-based processing step and reported.

In certain embodiments, the above described quantities are related to the spatial (or antenna), delay (or frequency), and/or doppler (or time) domain channel property, and one or more of these can be reported by the UE via b_{model}. The bit sequence b_{model} has a predefined order so that gNB knows how to map the corresponding part of b_{model} to a certain extracted feature. For example, suppose that dominant beam and dominant delay are reported by the UE, with N_{b} and N_{d} bits respectively. Then the first N_{b} bits in are used to report the selected beams and the last N_{d} bits are used for reporting the selected delays.

In a particular embodiment, the CSI extracted from this step is reported with higher priority comparing to the CSI extracted from the AE-based processing step. The reason is that this part of the CSI is meaningful, or human interpretable, even if the remaining part of the CSI is not reported. That is, b_{model} may contain dominant channel direction, delay, and/or doppler information.

In addition, the validity of this part can be in general longer in time, and if the network assumes the remaining CSI, e.g., b_{AE}, which may contain the fast fading information, is not needed, it can schedule a small PUSCH resource so that the remaining CSI, e.g., b_{AE}, is dropped and not transmitted by the UE.

Furthermore, the extracted CSI from this step is usually wideband, or at least can be consider unchanged over a number of subbands, hence the payload is relatively small comparing to b_{AE} extracted from the AE-based compression step, which is described in more detail below. Thus, when mapping b_{model} to the UCI bit sequence, bits in b_{model} should have higher priority than the bits in b_{AE}.

It may be noted that the since the model-based processing step may be optional, then, in that case, reporting of b_{model} is apparently not needed.

Reporting of Channel Features Extracted from the AE-based Processing Step

The AE-based processing step can be used by the UE to further compress the channel after the model-based processing step. In general, this step extracts fine details of the channel information (e.g., small-scale fast fading channel coefficients), such information is represented by quantized complex values, e.g., b_{AE} in FIG. 5. The quantized complex values are preferably generated directly by the encoder side, but in principle they can also be generated by quantizing the encoder output. Herein, a quantized complex value could be either quantized separately per real and imaginary part, or it can be quantized for the amplitude and phase separately. The quantization can either be performed in logarithmic scale or liner scale. The quantization can also be scalar or a vector quantization approach (on multiple output variables jointly). All the quantized values are packed in a bit sequence, e.g., b_{AE}, and reported to the gNB in a CSI report. Such CSI report should be transmitted in CSI Part 2, or some newly define type of CSI segments (e.g., CSI Part 3, AI CSI).

### Determination of the Bitwidth of b_{AE}

The bit sequence b_{AE} needs to be standardized so that the gNB can correctly decode the CSI that is carried by b_{AE}. In particular, one or more of the following may be standardized.

In a particular embodiment, the number of bits (e.g., denoted as N_{AE}) generated from the encoder, i.e., the bitwidth of b_{AE}, is standardized. This bitwidth may then be used in 3GPP TS 38.212 to describe the fields in a new reportQuantity, for example “AI-RI-CQI”, where AI is bits related to the AI CSI, that is the latent space, i.e. field of NAE bits plus eventual model based bits b_{model}. In 3GPP specification, NAE can be standardized explicitly, or it can be inferred from other dependent parameters. To further explain the latter, one example could be that the number of bits, herein denoted by N_{bits}, for quantizing each complex coefficients is standardized (e.g., Nₐ bits for the amplitude and Nₚ bits for the phase, or Nᵣ bits for the real part and Nᵢ bits for the imaginary part). Furthermore, the number of outputs from the last layer before the quantization layer (denoted as N), which contains unquantized complex valued output is standardized. Then, the number of bits NAE could be equal to NN_{bits} (or NN_{bits}v where v is the number of transmission layers).

In another particular embodiment, the number of bits generated from the encoder, i.e., the bitwidth of b_{AE}, may depend on the AI/ML model that is used for CSI compression. Such model could be either gNB configured or it could be selected by the UE from a number of candidates. When the model is selected by the UE, the selected model (i.e., model ID) needs to be reported to the gNB. For example, if 8 AI/ML models are possible candidates that can be used by the UE to compress CSI, then 3 bits are needed to tell the gNB which model is selected by the UE, e.g., “000” refers to the first model, ‘“001” refers to the second model, . . . , “111” refers to the 8^{th} model. In a particular embodiment, the selected model, if reported, is reported to the gNB in CSI Part 1. In this way, the gNB can first decode CSI Part 1 to figure out the payload size of b_{AE}, since gNB needs to determine the payload size of CSI Part 2, or some newly defined CSI segments (e.g., CSI Part 3, AI CSI) before being able to correctly decode it.

In another particular embodiment, the bits that are generated from the encoder are not all reported. Then, an indication of which bits are reported needs to be known by the gNB. In this case, the bits generated from the encoder can be grouped in a certain fashion, then one bit can be used to indicate if a particular group of bits are reported or not. For example, starting from a given bit, assuming every consecutive of k bits are associated with a certain complex value, then one bit can be used to denote if the k bits are reported or not. This can save overhead when a group of bits are associated with some negligible values. In a particular embodiment, the number of selected/reported bit groups that are included in the CSI report, if reported, is reported to the gNB in CSI Part 1. Then, the gNB can first decode CSI Part 1 to figure out the payload size of b_{AE}, since gNB needs to determine the payload size of CSI Part 2, or some newly defined CSI segments (e.g., CSI Part 3, AI CSI) before being able to correctly decode it.

In the above, both the model ID and the number of reported bit groups, if reported, do not directly provide any channel information. Instead, this is auxiliary information that can help the gNB to decode the a CSI report. Hereafter, b_{AUX} is denoted as the bit sequence that is used to report such auxiliary information, which can be reported in CSI Part 1.

### Segmentation of b_{AE}

The bit sequence b_{AE} could have much heavier payload than b_{model}. Accordingly, in a particular embodiment, it may be more reasonable to further divide the bit sequence b_{AE} into multiple segments, which can be transmitted in CSI Part 2, or some new type of CSI segment (e.g., CSI Part 3, or CSI Part AI). One benefit of doing so is that it is possible to drop some part(s) of b_{AE} when the allocated UCI resource (e.g., PUSCH allocation, for carrying such CSI report is not sufficient), the reported incomplete CSI can still be used by the gNB to retrieve partial CSI. Some embodiments are described below for exemplifying the above.

For example, in a particular embodiment, b_{AE} is segmented into multiple parts based on a certain fashion, where each part contains a non-overlapping subset of bits from b_{AE}. For example, in some cases, every k consecutive bits may be associated with a certain value (either complex or real). Then, such grouping is beneficial when some groups are associated with very weak values, so they can be dropped in order to save overhead, without significant impact on performance.

In a particular embodiment, b_{AE} is segmented based on the transmission layer, where each segment of b_{AE} is associated with one or multiple of transmission layers.

In another particular embodiment, b_{AE} is segmented based on the frequency domain information of the CSI (e.g., carrier frequency, PMI/CQI subbands, etc.).

In another particular embodiment, b_{AE} is segmented based on the time domain information of the CSI (e.g., the channel and/or the PMI for some given time instance(s)). For example, a reported CSI/PMI may be time-dependent, which can be applied by the gNB for scheduling DL transmission at different time instances (e.g., for the current and a future time instance). In this case, the CSI/PMI that is valid for different time instances can be contained in different segments of b_{AE}.

In yet another particular embodiment, any combination of the above-mentioned segmentations can be applied to b_{AE}.

The different segments of b_{AE} can be transmitted on one or multiple parts of the CSI. In one embodiment, different segments of b_{AE} are transmitted on the same CSI segment at its entirety, such as CSI Part 2, or some new type of CSI segment (e.g., CSI Part 3, or CSI Part AI). In another embodiment, different segments of b_{AE} are transmitted on multiple CSI segments (e.g., some on CSI Part 2, others on some new type of CSI segment). In a particular embodiment, for the segment of b_{AE} transmitted on CSI Part 2, or on the new type of CSI segment (e.g., CSI Part 3, or CSI Part AI), the said segment of b_{AE} can be transmitted on different sub-segments of the said CSI segment.

Segmentation can also be done according to a clearly defined priority function, then the bit sequence b_{AE} can be segmented based on the priority level of each bit. For example, the bits are sorted according the priority level in descending order, and every consecutive n bits form a segment/group of bits. Following are some related embodiments.

In a particular embodiment, a priority function p(.) is defined for the bit sequence b_{AE}, where p(.) determines a priority level for each bit therein. The priority function p(.) may depend on one or multiple of the following: a transmission layer index, a port index (e.g., CSI-RS port index, antenna port index, etc.), a spatial domain index (e.g., a beam index), a frequency domain index (e.g., carrier index, subband index, frequency/delay-domain basis index, etc.), a time domain index (e.g., time/Doppler-domain basis index, symbol index, slot index, etc.), some node index of the AI/ML model (if the encoder/decoder nodes have been indexed), an index of the AI/ML model, an index for the type of report (e.g., 0 for Type I report, 1 for Type II report, 2 for AI-CSI report, 3 for Type I+AI-CSI reports, 4 for Type II+AI-CSI reports, etc.), a CSI report index, etc.

In a further particular embodiment, each bit in b_{AE} has an unique priority level.

In another particular embodiment, a group of bits in b_{AE} share the same priority level. For example, all bits associated with the same layer have the same priority level.

Mapping Order of b_{AUX}, b_{model} and b_{AE} to UCI Bit Sequence

In a particular embodiment, the bit sequences b_{AUX}, b_{model} and b_{AE}, if reported, may be mapped to the UCI bit sequence, and then transmitted to the gNB. In the sequel, according to a particular embodiment, this mapping is divided into two steps: the first step is mapping of b_{AUX}, b_{model} and b_{AE} onto different parts of one CSI report, e.g., CSI Part 1, CSI Part 2, etc., while the second step is mapping of multiple CSI reports onto UCI bit sequence. Note that this two-step mapping is mainly for illustration/explanation purpose; one can also treat this as a single step mapping.

Mapping Order of b_{AUX}, b_{model} and b_{AE} in one CSI Report

In a particular embodiment, the mapping order of b_{AUX}, b_{model} and b_{AE} in one CSI report depends on if they are actually reported, and if reported, what are the actual CSI quantities/content carried in them. In general, the priority in descend order would be b_{AUX}>b_{model}>b_{AE}. In the following, the mapping will be explained with examples. Other possibilities that are not listed in the examples are not ruled out.

Example 1 (PMI-based reporting), the following quantities may be reported:
Legacy quantities: CRI, RI, CQI
b_{AUX}: AI/ML model ID, the number of bit groups to be reported in b_{AE}, the number of selected SD/FD/TD basis
b_{model}: selected SD basis, FD basis, TD basis
b_{AE}: bits that are segmented so that each segment is associated with a transmission layer for a given time instance.

TABLE 2
Mapping order of b_{AUX}, b_{model} and b_{AE} to different parts/sub-parts
of one CSI report for PMI-based reporting

| CSI report | |
|---|---|
| number | CSI fields |
| CSI report #n, | CRI, if reported |
| CSI part 1 | RI, if reported |
| | Wideband CQI, if reported |
| | Subband CQI, if reported |
| | Bits in b_{AUX} that correspond to number of selected SD basis in b_{model}, if reported |
| | Bits in b_{AUX} that correspond to number of selected FD basis in b_{model}, if reported |
| | Bits in b_{AUX} that correspond to number of selected TD basis in b_{model}, if reported |
| | Bits in b_{AUX} that correspond to the selected model ID used for producing b_{AE}, if reported |
| | Bits in b_{AUX} that correspond to the number of reported bit groups in b_{AE}, if reported |
| CSI report #n | Bits in b_{model} that correspond to the selected SD basis, if reported |
| CSI part 2, | Bits in b_{model} that correspond to the selected FD basis, if reported |
| Group 0 | Bits in b_{model} that correspond to the selected TD basis, if reported |
| | A bitmap indicating which bit groups are reported in b_{AE}, if reported |
| CSI report #n | Bits in b_{AE} that correspond to the 1^{st} transmission layer at time instance t₀, if reported |
| CSI part 2, | Bits in b_{AE} that correspond to the 2^{nd} transmission layer at time instance t₀, if reported |
| Group 1 | . . . |
| | Bits in b_{AE} that correspond to the v^{th} transmission layer at time instance t₀, if reported |
| CSI report #n | Bits in b_{AE} that correspond to the 1^{st} transmission layer at time instance t₁, if reported |
| CSI part 2, | Bits in b_{AE} that correspond to the 2^{nd} transmission layer at time instance t₁, if reported |
| Group 2 | . . . |
| | Bits in b_{AE} that correspond to the v^{th} transmission layer at time instance t₁, if reported |
| . . . | . . . |
| CSI report #n | Bits in b_{AE} that correspond to the 1^{st} transmission layer at time instance tₘ₋₁, if reported |
| CSI part 2, | Bits in b_{AE} that correspond to the 2^{nd} transmission layer at time instance tₘ₋₁, if reported |
| Group g | . . . |
| | Bits in b_{AE} that correspond to the v^{th} transmission layer at time instance tₘ₋₁, if reported |

In Table 2, v denotes the number of transmission layers indicated to the gNB by the UE, and tₘ denotes a time instance and it is assumed tₘ₊₁>tₘ, i.e., tₘ₊₁ happens later.

However, the above table is just for illustration. Reports carried on CSI Part 2 (including different groups therein) can also be reported in other ways, e.g., in a single group within Part 2, or in some newly defined type of CSI segments that is specifically designed for AI-based CSI reporting.

In addition, the order of the mapping can also be different. In the above example, the mapping order is first by layer, then by time. It could also be first by time, then by layer, etc. Also, mapping to the groups can be defined by a priority function as described herein.

Example 2 (explicit channel reporting), the following quantities may be reported:
b_{AUX}: AI/ML model ID, number of bit groups to be reported in b_{AE}
b_{model}: selected SD basis, FD basis, TD basis
b_{AE}: bits that are segmented so that each segment is associated the channel in some form (e.g., in the angle-delay-doppler domain with reduced dimensions) for a given time instance.

TABLE 3
Mapping order of b_{AUX}, b_{model} and b_{AE} to different parts/sub-parts
of one CSI report for explicit channel reporting

| CSI report | |
|---|---|
| number | CSI fields |
| CSI report #n, | Bits in b_{AUX} that correspond to number of selected SD basis in b_{model}, if reported |
| CSI part 1 | Bits in b_{AUX} that correspond to number of selected FD basis in b_{model}, if reported |
| | Bits in b_{AUX} that correspond to number of selected TD basis in b_{model}, if reported |
| | Bits in b_{AUX} that correspond to the selected model ID used for producing b_{AE}, if reported |
| | Bits in b_{AUX} that correspond to the number of reported bit groups in b_{AE}, if reported |
| CSI report #n | Bits in b_{model} that correspond to the selected SD basis, if reported |
| CSI part AI, | Bits in b_{model} that correspond to the selected FD basis, if reported |
| Group 0 | Bits in b_{model} that correspond to the selected TD basis, if reported |
| | A bitmap indicating which bit groups are reported in b_{AE}, if reported |
| CSI report #n | Bits in b_{AE} that correspond to the channel at time instance t₀, if reported |
| CSI part AI, | Bits in b_{AE} that correspond to the channel at time instance t₁, if reported |
| Group 1 | . . . |
| | Bits in b_{AE} that correspond to the channel at time instance tₘ, if reported |

For both of the above examples, the actual content in each part of the CSI depends on how b_{model} and b_{AE} are segmented. More examples of segmentation methods such as, for example, segmenting based on the priority level of each bit, are described above.

Also, it may also happen that when all the contents within a CSI part are not reported, the said part of CSI report is transmitted on UCI. For example, in the second example with explicit channel feedback, CSI part 1 may not be needed, and only CSI Part AI is sufficient for transmitting the CSI report.

### Mapping Order of CSI Reports to UCI Bit Sequence

A number of UCI bit sequences are generated in order to carry the CSI report, which may be transmitted on PUCCH or PUSCH. As per NR 3GPP Release 17, two bit sequences are created,

$${a}_{0}^{( 1 )} , {a}_{1}^{( 1 )} , {a}_{2}^{( 1 )} , {a}_{3}^{( 1 )} , … , {a}_{{A}^{( 1 )} - 1}^{( 1 )}$$

### for CSI Part 1, and

$${a}_{0}^{( 2 )} , {a}_{1}^{( 2 )} , {a}_{2}^{( 2 )} , {a}_{3}^{( 2 )} , … , {a}_{{A}^{( 2 )} - 1}^{( 2 )}$$

for CSI Part 2, where A⁽¹⁾ and A⁽²⁾ are the number of bits in CSI Part 1 and Part 2, respectively. For the AI-based CSI reporting, a new bit sequence may be generated to carry some part(s) of the AI-based CSI report, e.g.,

$${a}_{0}^{( 3 )} , {a}_{1}^{( 3 )} , {a}_{2}^{( 3 )} , {a}_{3}^{( 3 )} , … , {a}_{{A}^{( 3 )} - 1}^{( 3 )} ,$$

where A⁽³⁾ is the total number of bits in the new part of CSI for AI. Note that when AI CSI is configured, the above sequences are only transmitted only if they are used to carry certain part(s) of the CSI report.

In the following, examples are given to illustrate the mapping order of multiple CSI reports to the corresponding bit sequences.

The mapping order of Part 1 CSI to the UCI bit sequence

$${a}_{0}^{( 1 )} , {a}_{1}^{( 1 )} , {a}_{2}^{( 1 )} , {a}_{3}^{( 1 )} , … , {a}_{{A}^{( 1 )} - 1}^{( 1 )}$$

can be done in the same way as is already defined in Table 6.3.2.1.2-16 in 3GPP NR Release 17 TS 38.214 V17.2.0 and, thus, is omitted here.

The mapping order of Part 2 CSI for the UCI bit sequence

$${a}_{0}^{( 2 )} , {a}_{1}^{( 2 )} , {a}_{2}^{( 2 )} , {a}_{3}^{( 2 )} , … , {a}_{{A}^{( 2 )} - 1}^{( 2 )}$$

can be done either by prioritizing the report number, or the group number. When the report number is prioritized, as shown in Table 4, this is to extend the existing mapping with more groups. When the group number is prioritized, as shown in Table 5, it is then more important to ensure that a complete report is transmitted first. If there is any remaining resource, it can be used to transmit additional reports.

TABLE 4
$Mapping order of CSI reports to UCI bit sequence {a}_{0}^{( 2 )} , {a}_{1}^{( 2 )} , {a}_{2}^{( 2 )} , {a}_{3}^{( 2 )} , … , {a}_{{A}^{( 2 )} - 1}^{( 2 )} ,$
where group has higher priority

| UCI bit sequence | CSI report number |
|---|---|
| ${a}_{0}^{( 2 )} , {a}_{1}^{( 2 )} , {a}_{2}^{( 2 )} , {a}_{3}^{( 2 )} , … , {a}_{{A}^{( 2 )} - 1}^{( 2 )}$ | CSI report #1, CSI part 2, Group 0 CSI report #2, CSI part 2, Group 0 |
| | . . . |
| | CSI report #n, CSI part 2, Group 0 |
| | CSI report #1, CSI part 2, Group 1 |
| | CSI report #2, CSI part 2, Group 1 |
| | . . . |
| | CSI report #n, CSI part 2, Group 1 |
| | . . . |
| | CSI report #1, CSI part 2, Group g |
| | CSI report #2, CSI part 2, Group g |
| | . . . |
| | CSI report #n, CSI part 2, Group g |

TABLE 5
$Mapping order of CSI reports to UCI bit sequence {a}_{0}^{( 2 )} , {a}_{1}^{( 2 )} , {a}_{2}^{( 2 )} , {a}_{3}^{( 2 )} , … , {a}_{{A}^{( 2 )} - 1}^{( 2 )} ,$
where report number has higher priority

| UCI bit sequence | CSI report number |
|---|---|
| ${a}_{0}^{( 2 )} , {a}_{1}^{( 2 )} , {a}_{2}^{( 2 )} , {a}_{3}^{( 2 )} , … , {a}_{{A}^{( 2 )} - 1}^{( 2 )}$ | CSI report #1, CSI part 2, Group 0 CSI report #1, CSI part 2, Group 1 |
| | . . . |
| | CSI report #1, CSI part 2, Group g |
| | CSI report #2, CSI part 2, Group 0 |
| | CSI report #2, CSI part 2, Group 1 |
| | . . . |
| | CSI report #2, CSI part 2, Group g |
| | . . . |
| | CSI report #n, CSI part 2, Group 0 |
| | CSI report #n, CSI part 2, Group 1 |
| | . . . |
| | CSI report #n, CSI part 2, Group g |

If a new CSI part is defined for the AI CSI such as, for example, CSI Part 3, then the mapping order to the UCI bit sequence

$${a}_{0}^{( 3 )} , {a}_{1}^{( 3 )} , {a}_{2}^{( 3 )} , {a}_{3}^{( 3 )} , … , {a}_{{A}^{( 3 )} - 1}^{( 3 )}$$

can be done either by prioritizing the report number, or the group number. When the report number is prioritized, as shown in Table 6, it is then more important to transmit some information each report than totally missing that report, which may happen when CSI omission happens. When the group number is prioritized, as shown in Table 7, it is then more important to ensure that a complete report is transmitted first. If there is any remaining resource, it can be used to transmit additional reports.

TABLE 6
$Mapping order of CSI reports to UCI bit sequence {a}_{0}^{( 2 )} , {a}_{1}^{( 2 )} , {a}_{2}^{( 2 )} , {a}_{3}^{( 2 )} , … , {a}_{{A}^{( 2 )} - 1}^{( 2 )} ,$
where group has higher priority

| UCI bit sequence | CSI report number |
|---|---|
| ${a}_{0}^{( 2 )} , {a}_{1}^{( 2 )} , {a}_{2}^{( 2 )} , {a}_{3}^{( 2 )} , … , {a}_{{A}^{( 2 )} - 1}^{( 2 )}$ | CSI report #1, CSI part 2, Group 0 CSI report #2, CSI part 2, Group 0 |
| | . . . |
| | CSI report #n, CSI part 2, Group 0 |
| | CSI report #1, CSI part 2, Group 1 |
| | CSI report #2, CSI part 2, Group 1 |
| | . . . |
| | CSI report #n, CSI part 2, Group 1 |
| | . . . |
| | CSI report #1, CSI part 2, Group g |
| | CSI report #2, CSI part 2, Group g |
| | . . . |
| | CSI report #n, CSI part 2, Group g |

TABLE 7
$Mapping order of CSI reports to UCI bit sequence {a}_{0}^{( 2 )} , {a}_{1}^{( 2 )} , {a}_{2}^{( 2 )} , {a}_{3}^{( 2 )} , … , {a}_{{A}^{( 2 )} - 1}^{( 2 )} ,$
where report number has higher priority

| UCI bit sequence | CSI report number |
|---|---|
| ${a}_{0}^{( 2 )} , {a}_{1}^{( 2 )} , {a}_{2}^{( 2 )} , {a}_{3}^{( 2 )} , … , {a}_{{A}^{( 2 )} - 1}^{( 2 )}$ | CSI report #1, CSI part 2, Group 0 CSI report #1, CSI part 2, Group 1 |
| | . . . |
| | CSI report #1, CSI part 2, Group g |
| | CSI report #2, CSI part 2, Group 0 |
| | CSI report #2, CSI part 2, Group 1 |
| | . . . |
| | CSI report #2, CSI part 2, Group g |
| | . . . |
| | CSI report #n, CSI part 2, Group 0 |
| | CSI report #n, CSI part 2, Group 1 |
| | . . . |
| | CSI report #n, CSI part 2, Group g |

In some cases, the mapping order of b_{AE} to the UCI bit sequence does not need to standardized. Instead, it could be implicitly known by both at the gNB and at the UE side. For example, when the encoder and decoder are jointly trained and kept the same when deployed, then the mapping order of b_{AE} to the UCI bit sequence does not need to be known, since it is the same as used in the training phase.

### CSI Omission

With the proposed segmentation/packaging of CSI reporting for hybrid model-learning CSI compression, it is possible to drop part of the CSI when the allocated UCI size is not sufficient to carry the complete CSI report. To enable this, an omission rule may be defined, so that bits, or CSI parts/sub-parts, with lower priority will be dropped/omitted first. This procedure is repeated until the remaining UCI allocation is able to transmit the remaining CSI report with required BLER target. The omission rule is defined based on how the CSI report is segmented, as well as the report number. The CSI omission rules may only apply to Part 2 CSI and the newly defined CSI for AI-CSI, e.g., Part 3 CSI.

### Other Legacy Parameters

If other legacy CSI reporting parameters such as rank, layer, or CSI-RS resource indicators are also reported (RI, LI, CRI) for the report quantity, these can in one embodiment also be carried by the Part 1 report so that the Part 1 report can be used by the network to schedule a PDSCH transmission with the correct rank.

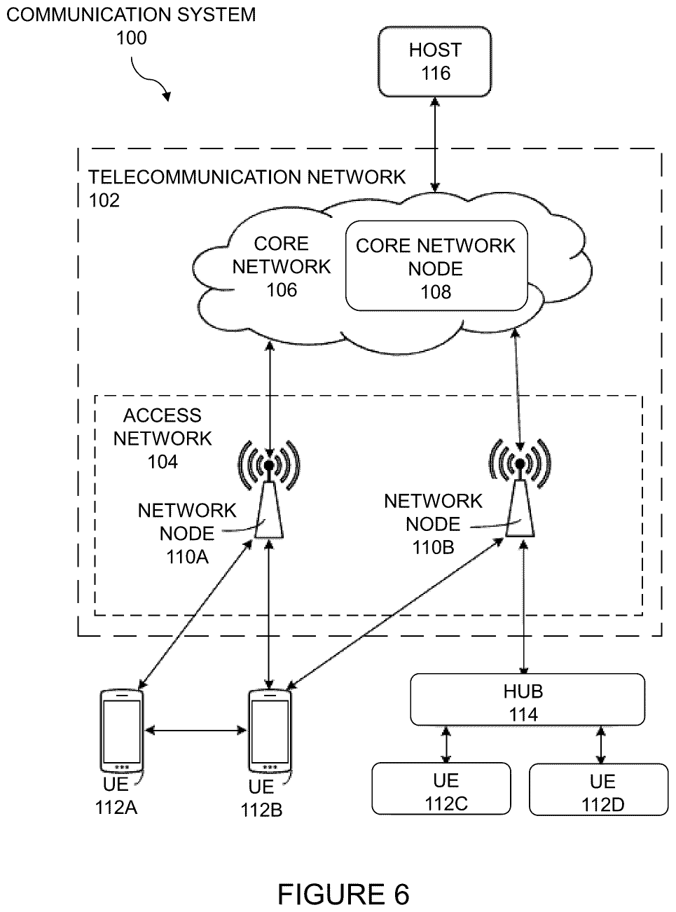

FIG. 6 shows an example of a communication system 100 in accordance with some embodiments. In the example, the communication system 100 includes a telecommunication network 102 that includes an access network 104, such as a radio access network (RAN), and a core network 106, which includes one or more core network nodes 108. The access network 104 includes one or more access network nodes, such as network nodes 110a and 110b (one or more of which may be generally referred to as network nodes 110), or any other similar 3^{rd} Generation Partnership Project (3GPP) access node or non-3GPP access point. The network nodes 110 facilitate direct or indirect connection of user equipment (UE), such as by connecting UEs 112a, 112b, 112c, and 112d (one or more of which may be generally referred to as UEs 112) to the core network 106 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 100 may include any number of wired or wireless networks, network nodes, UEs, and/or any other components or systems that may facilitate or participate in the communication of data and/or signals whether via wired or wireless connections. The communication system 100 may include and/or interface with any type of communication, telecommunication, data, cellular, radio network, and/or other similar type of system.

The UEs 112 may be any of a wide variety of communication devices, including wireless devices arranged, configured, and/or operable to communicate wirelessly with the network nodes 110 and other communication devices. Similarly, the network nodes 110 are arranged, capable, configured, and/or operable to communicate directly or indirectly with the UEs 112 and/or with other network nodes or equipment in the telecommunication network 102 to enable and/or provide network access, such as wireless network access, and/or to perform other functions, such as administration in the telecommunication network 102.

In the depicted example, the core network 106 connects the network nodes 110 to one or more hosts, such as host 116. These connections may be direct or indirect via one or more intermediary networks or devices. In other examples, network nodes may be directly coupled to hosts. The core network 106 includes one more core network nodes (e.g., core network node 108) that are structured with hardware and software components. Features of these components may be substantially similar to those described with respect to the UEs, network nodes, and/or hosts, such that the descriptions thereof are generally applicable to the corresponding components of the core network node 108. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 116 may be under the ownership or control of a service provider other than an operator or provider of the access network 104 and/or the telecommunication network 102, and may be operated by the service provider or on behalf of the service provider. The host 116 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 100 of FIG. 6 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 102 is a cellular network that implements 3GPP standardized features. Accordingly, the telecommunications network 102 may support network slicing to provide different logical networks to different devices that are connected to the telecommunication network 102. For example, the telecommunications network 102 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 112 are configured to transmit and/or receive information without direct human interaction. For instance, a UE may be designed to transmit information to the access network 104 on a predetermined schedule, when triggered by an internal or external event, or in response to requests from the access network 104. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio-Dual Connectivity (EN-DC).

In the example, the hub 114 communicates with the access network 104 to facilitate indirect communication between one or more UEs (e.g., UE 112c and/or 112d) and network nodes (e.g., network node 110b). In some examples, the hub 114 may be a controller, router, content source and analytics, or any of the other communication devices described herein regarding UEs. For example, the hub 114 may be a broadband router enabling access to the core network 106 for the UEs. As another example, the hub 114 may be a controller that sends commands or instructions to one or more actuators in the UEs. Commands or instructions may be received from the UEs, network nodes 110, or by executable code, script, process, or other instructions in the hub 114. As another example, the hub 114 may be a data collector that acts as temporary storage for UE data and, in some embodiments, may perform analysis or other processing of the data. As another example, the hub 114 may be a content source. For example, for a UE that is a VR headset, display, loudspeaker or other media delivery device, the hub 114 may retrieve VR assets, video, audio, or other media or data related to sensory information via a network node, which the hub 114 then provides to the UE either directly, after performing local processing, and/or after adding additional local content. In still another example, the hub 114 acts as a proxy server or orchestrator for the UEs, in particular in if one or more of the UEs are low energy IoT devices.

The hub 114 may have a constant/persistent or intermittent connection to the network node 110b. The hub 114 may also allow for a different communication scheme and/or schedule between the hub 114 and UEs (e.g., UE 112c and/or 112d), and between the hub 114 and the core network 106. In other examples, the hub 114 is connected to the core network 106 and/or one or more UEs via a wired connection. Moreover, the hub 114 may be configured to connect to an M2M service provider over the access network 104 and/or to another UE over a direct connection. In some scenarios, UEs may establish a wireless connection with the network nodes 110 while still connected via the hub 114 via a wired or wireless connection. In some embodiments, the hub 114 may be a dedicated hub—that is, a hub whose primary function is to route communications to/from the UEs from/to the network node 110b. In other embodiments, the hub 114 may be a non-dedicated hub—that is, a device which is capable of operating to route communications between the UEs and network node 110b, but which is additionally capable of operating as a communication start and/or end point for certain data channels.

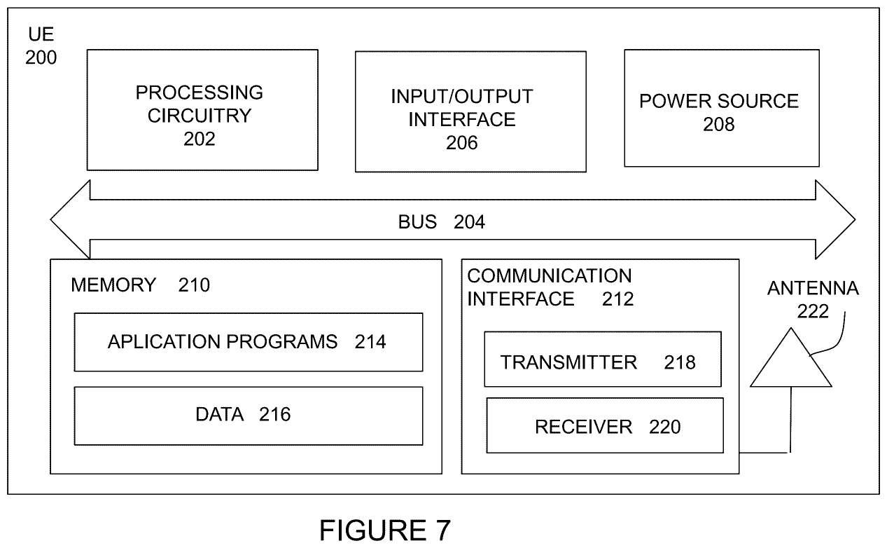

FIG. 7 shows a UE 200 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 200 includes processing circuitry 202 that is operatively coupled via a bus 204 to an input/output interface 206, a power source 208, a memory 210, a communication interface 212, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 202 is configured to process instructions and data and may be configured to implement any sequential state machine operative to execute instructions stored as machine-readable computer programs in the memory 210. The processing circuitry 202 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 202 may include multiple central processing units (CPUs).

In the example, the input/output interface 206 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 200. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 208 is structured as a battery or battery pack. Other types of power sources, such as an external power source (e.g., an electricity outlet), photovoltaic device, or power cell, may be used. The power source 208 may further include power circuitry for delivering power from the power source 208 itself, and/or an external power source, to the various parts of the UE 200 via input circuitry or an interface such as an electrical power cable. Delivering power may be, for example, for charging of the power source 208. Power circuitry may perform any formatting, converting, or other modification to the power from the power source 208 to make the power suitable for the respective components of the UE 200 to which power is supplied.

The memory 210 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 210 includes one or more application programs 214, such as an operating system, web browser application, a widget, gadget engine, or other application, and corresponding data 216. The memory 210 may store, for use by the UE 200, any of a variety of various operating systems or combinations of operating systems.

The memory 210 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 210 may allow the UE 200 to access instructions, application programs and the like, stored on transitory or non-transitory memory media, to off-load data, or to upload data. An article of manufacture, such as one utilizing a communication system may be tangibly embodied as or in the memory 210, which may be or comprise a device-readable storage medium.

The processing circuitry 202 may be configured to communicate with an access network or other network using the communication interface 212. The communication interface 212 may comprise one or more communication subsystems and may include or be communicatively coupled to an antenna 222. The communication interface 212 may include one or more transceivers used to communicate, such as by communicating with one or more remote transceivers of another device capable of wireless communication (e.g., another UE or a network node in an access network). Each transceiver may include a transmitter 218 and/or a receiver 220 appropriate to provide network communications (e.g., optical, electrical, frequency allocations, and so forth). Moreover, the transmitter 218 and receiver 220 may be coupled to one or more antennas (e.g., antenna 222) and may share circuit components, software or firmware, or alternatively be implemented separately.

In the illustrated embodiment, communication functions of the communication interface 212 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 212, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 200 shown in FIG. 7.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

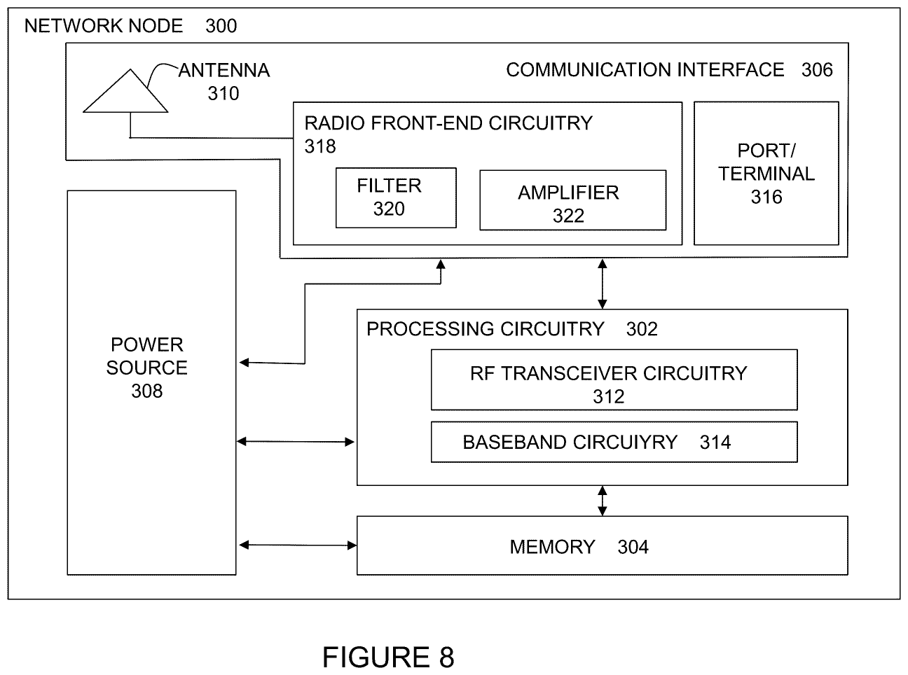

FIG. 8 shows a network node 300 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 300 includes a processing circuitry 302, a memory 304, a communication interface 306, and a power source 308. The network node 300 may be composed of multiple physically separate components (e.g., a NodeB component and a RNC component, or a BTS component and a BSC component, etc.), which may each have their own respective components. In certain scenarios in which the network node 300 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 300 may be configured to support multiple radio access technologies (RATs). In such embodiments, some components may be duplicated (e.g., separate memory 304 for different RATs) and some components may be reused (e.g., a same antenna 310 may be shared by different RATs). The network node 300 may also include multiple sets of the various illustrated components for different wireless technologies integrated into network node 300, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 300.

The processing circuitry 302 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 300 components, such as the memory 304, to provide network node 300 functionality.

In some embodiments, the processing circuitry 302 includes a system on a chip (SOC). In some embodiments, the processing circuitry 302 includes one or more of radio frequency (RF) transceiver circuitry 312 and baseband processing circuitry 314. In some embodiments, the radio frequency (RF) transceiver circuitry 312 and the baseband processing circuitry 314 may be on separate chips (or sets of chips), boards, or units, such as radio units and digital units. In alternative embodiments, part or all of RF transceiver circuitry 312 and baseband processing circuitry 314 may be on the same chip or set of chips, boards, or units.

The memory 304 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 302. The memory 304 may store any suitable instructions, data, or information, including a computer program, software, an application including one or more of logic, rules, code, tables, and/or other instructions capable of being executed by the processing circuitry 302 and utilized by the network node 300. The memory 304 may be used to store any calculations made by the processing circuitry 302 and/or any data received via the communication interface 306. In some embodiments, the processing circuitry 302 and memory 304 is integrated.

The communication interface 306 is used in wired or wireless communication of signaling and/or data between a network node, access network, and/or UE. As illustrated, the communication interface 306 comprises port(s)/terminal(s) 316 to send and receive data, for example to and from a network over a wired connection. The communication interface 306 also includes radio front-end circuitry 318 that may be coupled to, or in certain embodiments a part of, the antenna 310. Radio front-end circuitry 318 comprises filters 320 and amplifiers 322. The radio front-end circuitry 318 may be connected to an antenna 310 and processing circuitry 302. The radio front-end circuitry may be configured to condition signals communicated between antenna 310 and processing circuitry 302. The radio front-end circuitry 318 may receive digital data that is to be sent out to other network nodes or UEs via a wireless connection. The radio front-end circuitry 318 may convert the digital data into a radio signal having the appropriate channel and bandwidth parameters using a combination of filters 320 and/or amplifiers 322. The radio signal may then be transmitted via the antenna 310. Similarly, when receiving data, the antenna 310 may collect radio signals which are then converted into digital data by the radio front-end circuitry 318. The digital data may be passed to the processing circuitry 302. In other embodiments, the communication interface may comprise different components and/or different combinations of components.

In certain alternative embodiments, the network node 300 does not include separate radio front-end circuitry 318, instead, the processing circuitry 302 includes radio front-end circuitry and is connected to the antenna 310. Similarly, in some embodiments, all or some of the RF transceiver circuitry 312 is part of the communication interface 306. In still other embodiments, the communication interface 306 includes one or more ports or terminals 316, the radio front-end circuitry 318, and the RF transceiver circuitry 312, as part of a radio unit (not shown), and the communication interface 306 communicates with the baseband processing circuitry 314, which is part of a digital unit (not shown).

The antenna 310 may include one or more antennas, or antenna arrays, configured to send and/or receive wireless signals. The antenna 310 may be coupled to the radio front-end circuitry 318 and may be any type of antenna capable of transmitting and receiving data and/or signals wirelessly. In certain embodiments, the antenna 310 is separate from the network node 300 and connectable to the network node 300 through an interface or port.

The antenna 310, communication interface 306, and/or the processing circuitry 302 may be configured to perform any receiving operations and/or certain obtaining operations described herein as being performed by the network node. Any information, data and/or signals may be received from a UE, another network node and/or any other network equipment. Similarly, the antenna 310, the communication interface 306, and/or the processing circuitry 302 may be configured to perform any transmitting operations described herein as being performed by the network node. Any information, data and/or signals may be transmitted to a UE, another network node and/or any other network equipment.

The power source 308 provides power to the various components of network node 300 in a form suitable for the respective components (e.g., at a voltage and current level needed for each respective component). The power source 308 may further comprise, or be coupled to, power management circuitry to supply the components of the network node 300 with power for performing the functionality described herein. For example, the network node 300 may be connectable to an external power source (e.g., the power grid, an electricity outlet) via an input circuitry or interface such as an electrical cable, whereby the external power source supplies power to power circuitry of the power source 308. As a further example, the power source 308 may comprise a source of power in the form of a battery or battery pack which is connected to, or integrated in, power circuitry. The battery may provide backup power should the external power source fail.

Embodiments of the network node 300 may include additional components beyond those shown in FIG. 8 for providing certain aspects of the network node's functionality, including any of the functionality described herein and/or any functionality necessary to support the subject matter described herein. For example, the network node 300 may include user interface equipment to allow input of information into the network node 300 and to allow output of information from the network node 300. This may allow a user to perform diagnostic, maintenance, repair, and other administrative functions for the network node 300.

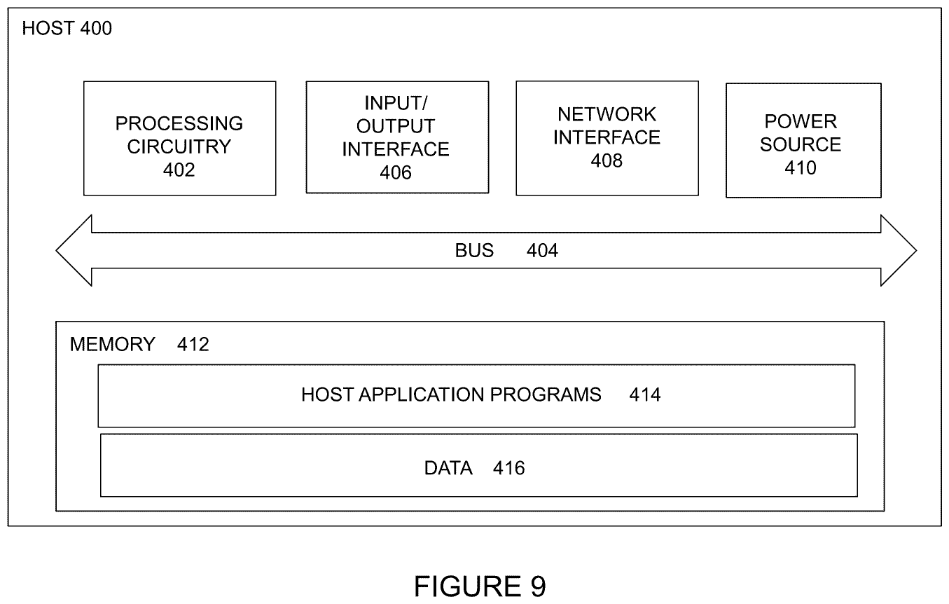

FIG. 9 is a block diagram of a host 400, which may be an embodiment of the host 116 of FIG. 6, in accordance with various aspects described herein. As used herein, the host 400 may be or comprise various combinations hardware and/or software, including a standalone server, a blade server, a cloud-implemented server, a distributed server, a virtual machine, container, or processing resources in a server farm. The host 400 may provide one or more services to one or more UEs.

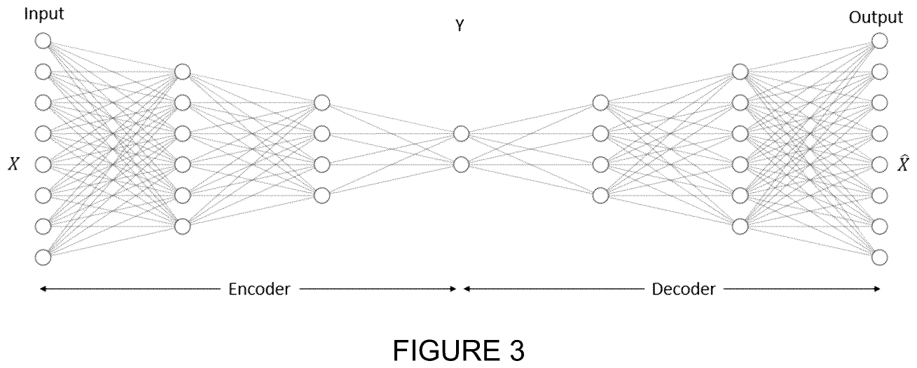

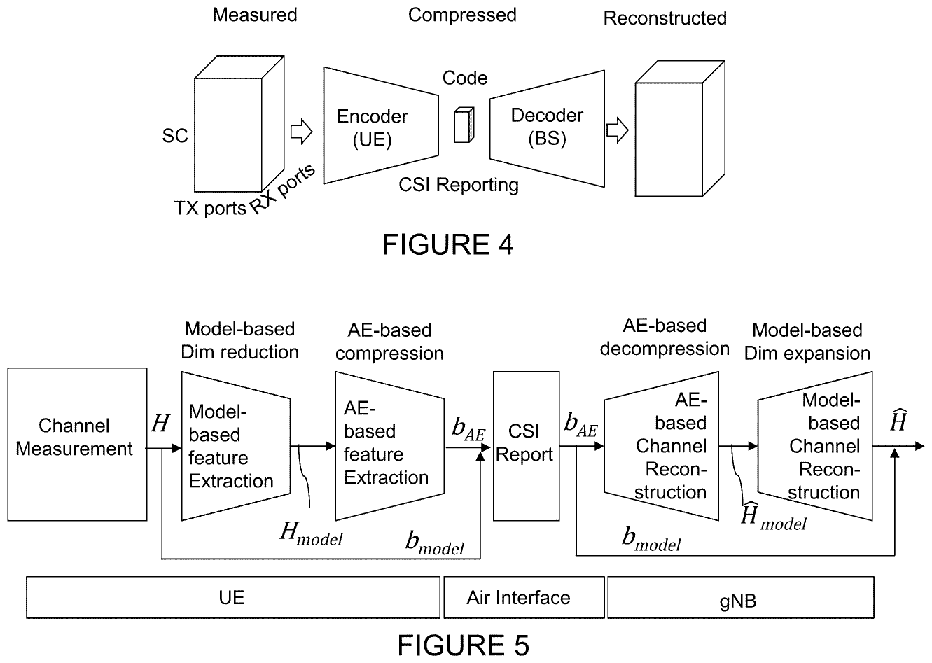

The host 400 includes processing circuitry 402 that is operatively coupled via a bus 404 to an input/output interface 406, a network interface 408, a power source 410, and a memory 412. Other components may be included in other embodiments. Features of these components may be substantially similar to those described with respect to the devices of previous figures, such as FIGS. 2 and 3, such that the descriptions thereof are generally applicable to the corresponding components of host 400.

The memory 412 may include one or more computer programs including one or more host application programs 414 and data 416, which may include user data, e.g., data generated by a UE for the host 400 or data generated by the host 400 for a UE. Embodiments of the host 400 may utilize only a subset or all of the components shown. The host application programs 414 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 414 may also provide for user authentication and licensing checks and may periodically report health, routes, and content availability to a central node, such as a device in or on the edge of a core network. Accordingly, the host 400 may select and/or indicate a different host for over-the-top services for a UE. The host application programs 414 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

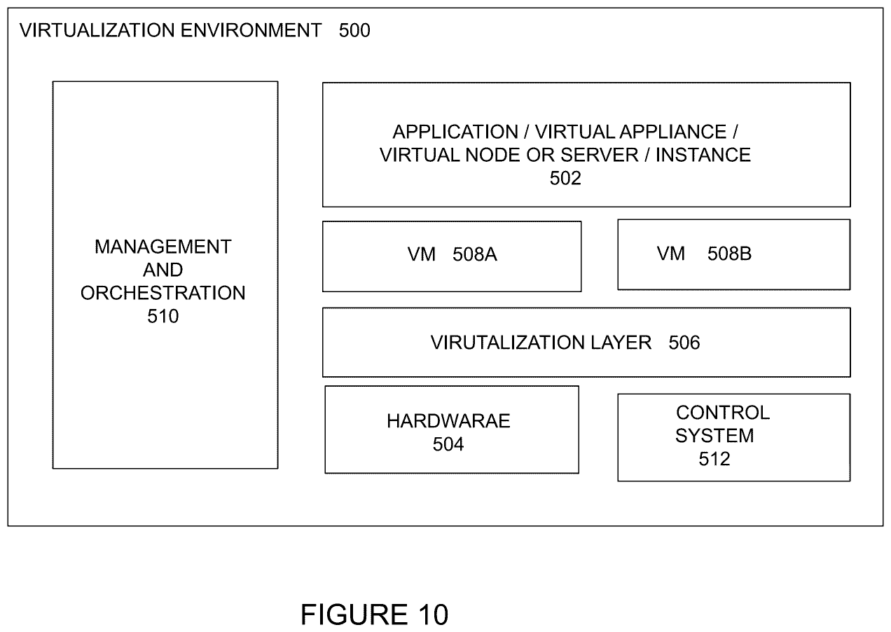

FIG. 10 is a block diagram illustrating a virtualization environment 500 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 500 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 502 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 504 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 506 (also referred to as hypervisors or virtual machine monitors (VMMs)), provide VMs 508a and 508b (one or more of which may be generally referred to as VMs 508), and/or perform any of the functions, features and/or benefits described in relation with some embodiments described herein. The virtualization layer 506 may present a virtual operating platform that appears like networking hardware to the VMs 508.

The VMs 508 comprise virtual processing, virtual memory, virtual networking or interface and virtual storage, and may be run by a corresponding virtualization layer 506. Different embodiments of the instance of a virtual appliance 502 may be implemented on one or more of VMs 508, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 508 may be a software implementation of a physical machine that runs programs as if they were executing on a physical, non-virtualized machine. Each of the VMs 508, and that part of hardware 504 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 508 on top of the hardware 504 and corresponds to the application 502.

Hardware 504 may be implemented in a standalone network node with generic or specific components. Hardware 504 may implement some functions via virtualization. Alternatively, hardware 504 may be part of a larger cluster of hardware (e.g. such as in a data center or CPE) where many hardware nodes work together and are managed via management and orchestration 510, which, among others, oversees lifecycle management of applications 502. In some embodiments, hardware 504 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 512 which may alternatively be used for communication between hardware nodes and radio units.

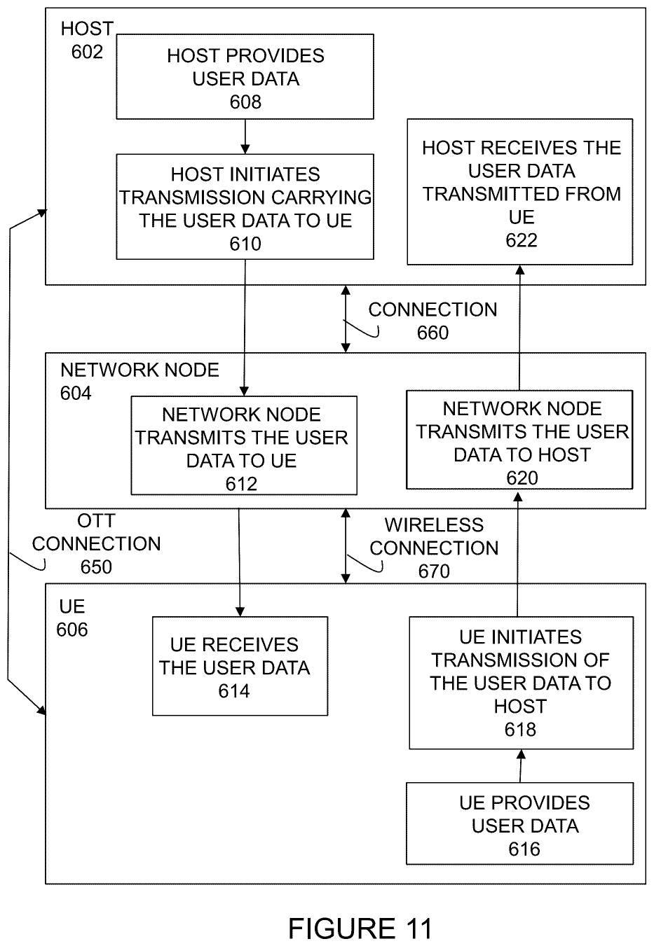

FIG. 11 shows a communication diagram of a host 602 communicating via a network node 604 with a UE 606 over a partially wireless connection in accordance with some embodiments.

Example implementations, in accordance with various embodiments, of the UE (such as a UE 112a of FIG. 6 and/or UE 200 of FIG. 7), network node (such as network node 110a of FIG. 6 and/or network node 300 of FIG. 8), and host (such as host 116 of FIG. 6 and/or host 400 of FIG. 9) discussed in the preceding paragraphs will now be described with reference to FIG. 11.

Like host 400, embodiments of host 602 include hardware, such as a communication interface, processing circuitry, and memory. The host 602 also includes software, which is stored in or accessible by the host 602 and executable by the processing circuitry. The software includes a host application that may be operable to provide a service to a remote user, such as the UE 606 connecting via an over-the-top (OTT) connection 650 extending between the UE 606 and host 602. In providing the service to the remote user, a host application may provide user data which is transmitted using the OTT connection 650.

The network node 604 includes hardware enabling it to communicate with the host 602 and UE 606. The connection 660 may be direct or pass through a core network (like core network 106 of FIG. 6) and/or one or more other intermediate networks, such as one or more public, private, or hosted networks. For example, an intermediate network may be a backbone network or the Internet.

The UE 606 includes hardware and software, which is stored in or accessible by UE 606 and executable by the UE's processing circuitry. The software includes a client application, such as a web browser or operator-specific “app” that may be operable to provide a service to a human or non-human user via UE 606 with the support of the host 602. In the host 602, an executing host application may communicate with the executing client application via the OTT connection 650 terminating at the UE 606 and host 602. In providing the service to the user, the UE's client application may receive request data from the host's host application and provide user data in response to the request data. The OTT connection 650 may transfer both the request data and the user data. The UE's client application may interact with the user to generate the user data that it provides to the host application through the OTT connection 650.

The OTT connection 650 may extend via a connection 660 between the host 602 and the network node 604 and via a wireless connection 670 between the network node 604 and the UE 606 to provide the connection between the host 602 and the UE 606. The connection 660 and wireless connection 670, over which the OTT connection 650 may be provided, have been drawn abstractly to illustrate the communication between the host 602 and the UE 606 via the network node 604, without explicit reference to any intermediary devices and the precise routing of messages via these devices.

As an example of transmitting data via the OTT connection 650, in step 608, the host 602 provides user data, which may be performed by executing a host application. In some embodiments, the user data is associated with a particular human user interacting with the UE 606. In other embodiments, the user data is associated with a UE 606 that shares data with the host 602 without explicit human interaction. In step 610, the host 602 initiates a transmission carrying the user data towards the UE 606. The host 602 may initiate the transmission responsive to a request transmitted by the UE 606. The request may be caused by human interaction with the UE 606 or by operation of the client application executing on the UE 606. The transmission may pass via the network node 604, in accordance with the teachings of the embodiments described throughout this disclosure. Accordingly, in step 612, the network node 604 transmits to the UE 606 the user data that was carried in the transmission that the host 602 initiated, in accordance with the teachings of the embodiments described throughout this disclosure. In step 614, the UE 606 receives the user data carried in the transmission, which may be performed by a client application executed on the UE 606 associated with the host application executed by the host 602.

In some examples, the UE 606 executes a client application which provides user data to the host 602. The user data may be provided in reaction or response to the data received from the host 602. Accordingly, in step 616, the UE 606 may provide user data, which may be performed by executing the client application. In providing the user data, the client application may further consider user input received from the user via an input/output interface of the UE 606. Regardless of the specific manner in which the user data was provided, the UE 606 initiates, in step 618, transmission of the user data towards the host 602 via the network node 604. In step 620, in accordance with the teachings of the embodiments described throughout this disclosure, the network node 604 receives user data from the UE 606 and initiates transmission of the received user data towards the host 602. In step 622, the host 602 receives the user data carried in the transmission initiated by the UE 606.

One or more of the various embodiments improve the performance of OTT services provided to the UE 606 using the OTT connection 650, in which the wireless connection 670 forms the last segment. More precisely, the teachings of these embodiments may improve one or more of, for example, data rate, latency, and/or power consumption and, thereby, provide benefits such as, for example, reduced user waiting time, relaxed restriction on file size, improved content resolution, better responsiveness, and/or extended battery lifetime.

In an example scenario, factory status information may be collected and analyzed by the host 602. As another example, the host 602 may process audio and video data which may have been retrieved from a UE for use in creating maps. As another example, the host 602 may collect and analyze real-time data to assist in controlling vehicle congestion (e.g., controlling traffic lights). As another example, the host 602 may store surveillance video uploaded by a UE. As another example, the host 602 may store or control access to media content such as video, audio, VR or AR which it can broadcast, multicast or unicast to UEs. As other examples, the host 602 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 650 between the host 602 and UE 606, in response to variations in the measurement results. The measurement procedure and/or the network functionality for reconfiguring the OTT connection may be implemented in software and hardware of the host 602 and/or UE 606. In some embodiments, sensors (not shown) may be deployed in or in association with other devices through which the OTT connection 650 passes; the sensors may participate in the measurement procedure by supplying values of the monitored quantities exemplified above, or supplying values of other physical quantities from which software may compute or estimate the monitored quantities. The reconfiguring of the OTT connection 650 may include message format, retransmission settings, preferred routing etc.; the reconfiguring need not directly alter the operation of the network node 604. Such procedures and functionalities may be known and practiced in the art. In certain embodiments, measurements may involve proprietary UE signaling that facilitates measurements of throughput, propagation times, latency and the like, by the host 602. The measurements may be implemented in that software causes messages to be transmitted, in particular empty or ‘dummy’ messages, using the OTT connection 650 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

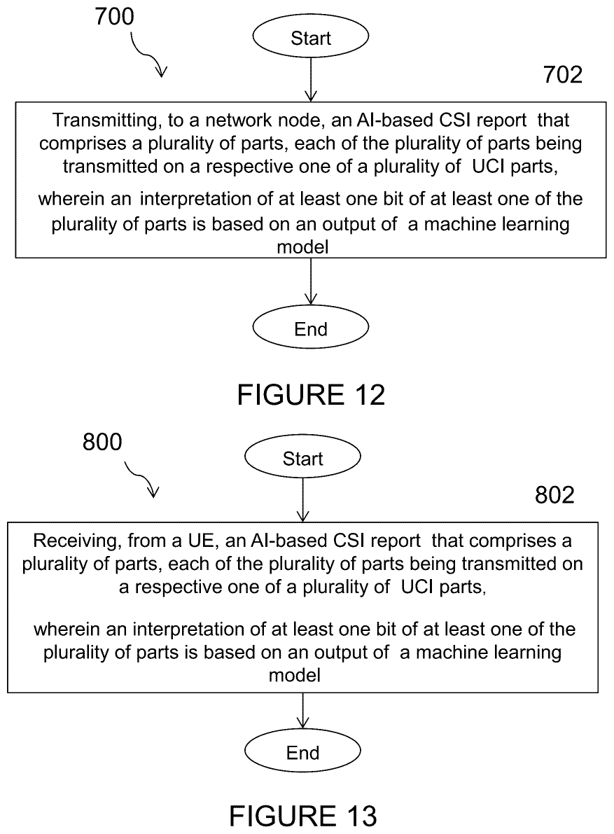

FIG. 12 illustrates a method 700 by a UE 112 for reporting CSI, according to certain embodiments. The method includes transmitting, to a network node 110, an AI-based CSI report that includes a plurality of parts, at step 702. Each of the plurality of parts are transmitted on a respective one of a plurality of UCI parts. An interpretation of at least one bit of at least one of the plurality of parts is based on an output of a ML model.

In a particular embodiment, the UE obtains CSI information and segments the CSI information into the plurality of parts.

In a particular embodiment, the CSI information comprises a plurality of bits. A priority level is assigned to each bit and/or each bit group. The UE identifies, based on the priority level assigned to each bit and/or each bit group, at least one bit or at least one bit group for the plurality of parts.

In a particular embodiment, when segmenting the CSI information into the plurality of parts, the UE segments the CSI information into at least two of: Part 1 CSI, Part 2 CSI, and Part 3 CSI. Part 1 CSI comprises information for decoding at least one of Part 2 CSI and Part 3 CSI.

In a further particular embodiment, at least one of the Part 2 CSI and the Part 3 CSI comprises CSI determined using the machine learning model.

In a further particular embodiment, the UE 112 determines that an allocated size of the UCI is less than a size of the obtained CSI information. Based on at least one omission rule, the UE 112 identifies at least one of the plurality of parts to be omitted from the AI-based CSI report.

In a further particular embodiment, the transmitted AI-based CSI report includes at least one of the Part 2 CSI and Part 3 CSI but the Part 1 CSI is omitted.

In a further particular embodiment, the transmitted AI-based CSI report includes the Part 1 CSI and the Part 3 CSI but the Part 2 CSI is omitted, and an interpretation of at least one bit of the Part 3 CSI is based on an output of the machine learning model.

In a further particular embodiment, the transmitted AI-based CSI report includes the Part 3 CSI but the Part 1 CSI and the Part 2 CSI is omitted, and an interpretation of at least one bit of the Part 3 CSI is based on an output of the machine learning model.

In a further particular embodiment, at least one of the Part 1 CSI, the Part 2 CSI, and the Part 3 CSI comprises a plurality of features extracted using the machine learning model, and the UE 112 orders the plurality of features based on an ordering scheme.

In a further particular embodiment, the plurality of features extracted using the machine learning model include a bit sequence, and the bit sequence is segmented into at least one of the plurality of parts, a plurality of sub-parts, and a plurality of groups.

In a further particular embodiment, the segmentation of the bit sequence is based on at least one of a priority function; a subset of nodes from an output layer of an AE; a transmission layer; spatial domain information provided by the CSI; frequency domain information provided by the CSI; and time domain information provided by the CSI.

In a particular embodiment, the UE 112 transmits, to the network node 110, an indication of a number of bits to be included the CSI report.

In a particular embodiment, the UE 112 receives, from the network node 110, an indication of a number of bits to be included in the CSI report.

In a particular embodiment, the machine learning model used by the UE is paired with a network node-side machine learning model.

In a further particular embodiment, the machine learning model used by the UE comprises an encoder portion of an auto-encoder, and wherein the network node-side machine learning model comprises a decoder portion of the auto-encoder.

FIG. 13 illustrates a method 800 by a network node 110 for receiving reported CSI, according to certain embodiments. The method includes receiving, from a UE 112, an AI-based CSI report that comprises a plurality of parts, at step 802. Each of the plurality of parts are received on a respective one of a plurality of UCI parts. An interpretation of at least one bit of at least one of the plurality of parts is based on an output of a machine learning model.

In a particular embodiment, the network node 110 uses the machine learning model to interpret the at least one bit of the at least one of the plurality of parts.

In a particular embodiment, the network node 110 configures the UE 112 to segment CSI information obtained by the UE into the plurality of parts.

In a further particular embodiment, the network node 110 transmits priority information to the UE, and the priority information indicates a plurality of priority levels to be assigned to bits and/or bit groups within CSI information obtained by the UE.

In a particular embodiment, the CSI report is segmented into at least two of Part 1 CSI, Part 2 CSI, and Part 3 CSI. The Part 1 CSI comprises information for decoding at least one of Part 2 CSI and Part 3 CSI.

In a further particular embodiment, at least one of the Part 2 CSI and the Part 3 CSI comprises CSI determined using the machine learning model.

In a further particular embodiment, the network node 110 transmits, to the UE 112, at least one omission rule for identifying at least one of the plurality of parts to be omitted from the AI-based CSI report.

In a further particular embodiment, the AI-based CSI report includes at least one of the Part 2 CSI and the Part 3 CSI but the Part 1 CSI is omitted.

In a further particular embodiment, the AI-based CSI report includes the Part 1 CSI and the Part 3 CSI but the Part 2 CSI is omitted, and an interpretation of at least one bit of the Part 3 CSI is based on an output of the machine learning model.

In a further particular embodiment, the AI-based CSI report includes the Part 3 CSI but the Part 1 CSI and the Part 2 CSI is omitted, and an interpretation of at least one bit of the Part 3 CSI is based on an output of the machine learning model.

In a particular embodiment, at least one of the Part 1 CSI, the Part 2 CSI, and the Part 3 CSI includes a plurality of features extracted from using the machine learning model, and the plurality of features are ordered based on an ordering scheme.

In a further particular embodiment, the plurality of features extracted using the machine learning model includes a bit sequence, and the bit sequence is segmented into at least one of: the plurality of parts, a plurality of sub-parts, and a plurality of groups.

In a further particular embodiment, the segmentation of the bit sequence is based on at least one of: a priority function; a subset of nodes from an output layer of an AE; a transmission layer; spatial domain information provided by the CSI; frequency domain information provided by the CSI; and time domain information provided by the CSI.

In a particular embodiment, the network node 110 transmits, to the UE 112, an indication of a number of bits to be included the CSI report.

In a particular embodiment, the network mode 110 receives, from the UE 112, an indication of a number of bits to be included the CSI report.

In a particular embodiment, the network node 110 determines a number of bits in the CSI report based on information in the CSI report.

In a particular embodiment, the machine learning model used by the network node is paired with a UE-side machine learning model.

In a further particular embodiment, the machine learning model used by the network node comprises a decoder portion of an auto-encoder, and the UE-side machine learning model comprises an encoder portion of the auto-encoder.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### EXAMPLE EMBODIMENTS

### Group A Example Embodiments

Example Embodiment A1. A method by a user equipment for reporting Channel State Information (CSI), the method comprising: any of the user equipment steps, features, or functions described above, either alone or in combination with other steps, features, or functions described above.

Example Embodiment A2. The method of the previous embodiment, further comprising one or more additional user equipment steps, features or functions described above.

Example Embodiment A3. The method of any of the previous embodiments, further comprising: providing user data; and forwarding the user data to a host computer via the transmission to the network node.

### Group B Example Embodiments

Example Embodiment B1. A method performed by a network node for receiving reported Channel State Information (CSI), the method comprising: any of the network node steps, features, or functions described above, either alone or in combination with other steps, features, or functions described above.

Example Embodiment B2. The method of the previous embodiment, further comprising one or more additional network node steps, features or functions described above.

Example Embodiment B3. The method of any of the previous embodiments, further comprising: obtaining user data; and forwarding the user data to a host or a user equipment.

### Group C Example Embodiments

Example Embodiment C1. A method by a user equipment (UE) for reporting Channel State Information (CSI), the method comprising: transmitting, to a network node, a CSI report that comprises a plurality of parts, each of the plurality of parts being transmitted on a respective one of a plurality of uplink control information (UCI) parts.

Example Embodiment C2. The method of Example Embodiment C1, wherein the UE is configured for AI-based CSI reporting.

Example Embodiment C3. The method of any one of Example Embodiments C1 to C2, comprising determining a content of each of the plurality of parts.

Example Embodiment C4. The method of any one of Example Embodiments C1 to C3, comprising obtaining CSI information.

Example Embodiment C5. The method of Example Embodiment C4, wherein all of the CSI information is included in the CSI report that is transmitted to the network node.

Example Embodiment C6. The method of Example Embodiment C4, comprising identifying at least a portion of the CSI information for omission from the CSI report, wherein the CSI report is less than all of the CSI information.

Example Embodiment C7. The method of any one of Example Embodiments C4 to C6, comprising segmenting the CSI information into the plurality of parts.

Example Embodiment C8. The method of Example Embodiments C4 to C7, wherein the CSI information comprises a plurality of bits.

Example Embodiment C9. The method of Example Embodiment C8, wherein a priority level is assigned to each bit and/or each bit group.

Example Embodiment C10. The method of Example Embodiment C9, comprising identifying, based on the priority level assigned to each bit and/or each bit group, at least one bit or at least one bit group for the plurality of parts.

Example Embodiment C11. The method of any one of Example Embodiments C9 to C10, comprising identifying, based on the priority level assigned to each bit and/or each bitt group, at least one bit or at least one bit group for omission from the plurality of parts.

Example Embodiment C12. The method of any one of Example Embodiments C1 to C11, wherein the CSI report is segmented into Part 1 CSI and Part 2 CSI.

Example Embodiment C13. The method of any one of Example Embodiments C1 to C12, wherein the CSI report includes Part 2 CSI but does not include Part 1 CSI.

Example Embodiment C14. The method of any one of Example Embodiments C1 to C12, wherein the CSI report is segmented into Part 1 CSI, Part 2 CSI, and Part 3 CSI, wherein the Part 3 CSI is for AI-CSI.

Example Embodiment C15. The method of any one of Example Embodiments C1 to C12, wherein the CSI report is segmented into Part 1 CSI and Part 3 CSI, wherein the Part 3 CSI is for AI-CSI.

Example Embodiment C16. The method of any one of Example Embodiments C1 to C12, wherein the CSI report includes Part 3 CSI but does not include Part 1 CSI or Part 2 CSI, and wherein the Part 3 CSI is for AI-CSI.

Example Embodiment C17. The method of any one of Example Embodiments C14 to C16, wherein the Part 3 CSI comprises a plurality of sub-parts.

Example Embodiment C18. The method of any one of Example Embodiments C12 to C17, wherein the Part 1 CSI, if included in the CSI report, includes at least one of. CRI, RI, CQI, and any information for decoding Part 2 CSI and/or Part 3 CSI.

Example Embodiment C19. The method of any one of Example Embodiments C12 to C18, wherein the Part 2 CSI, if included in the CSI report, includes at least one feature/CSI extracted from a AE-based processing step.

Example Embodiment C20. The method of any one of Example Embodiments C12 to C19, wherein the Part 3 CSI, if included in the CSI report, includes at least one feature/CSI extracted from a AE-based processing step.

Example Embodiment C21. The method of any one of Example Embodiments C1 to C20, wherein the CSI report includes a plurality of features/CSI extracted from a AE-based processing step, and the method further comprises ordering the plurality of features/CSI based on a standardized ordering scheme.

Example Embodiment C22. The method of any one of Example Embodiments C1 to C20, wherein the CSI report includes a plurality of features/CSI extracted from a AE-based processing step, and the method further comprises ordering the plurality of features/CSI based on an ordering scheme that is obtained through a joint training of an encoder and a decoder.

Example Embodiment C23. The method of any one of Example Embodiments C21 to C22, wherein the plurality of features/CSI extracted from the AE-based processing step comprises a bit sequence, the bit sequence being segmented into a plurality of parts, sub-parts, and/or groups.

Example Embodiment C24. The method of Example Embodiment C23, wherein the segmentation of the bit sequence is based on at least one of: a subset of nodes from an output layer of an AE; a Transmission layer; spatial domain information provided by the CSI; frequency domain information provided by the CSI; and time domain information provided by the CSI.

Example Embodiment C25. The method of any one of Example Embodiments C23 to C24, wherein the segmentation of the bit sequence is based on a priority function, and wherein the priority function depends on at least one of a transmission layer index; a CSI-RS or antenna port index; a basis index of some kind (e.g., spatial/frequency/time domain basis); an AI/ML model index; a Node index of an AI/ML model; an index for the type of CSI report; and a CSI report index.

Example Embodiment C26. The method of any one of Example Embodiments C1 to C25, wherein a number of bits in the CSI report is known to the network node.

Example Embodiment C27. The method of any one of Example Embodiments C1 to C26, comprising transmitting, to the network node, a number of bits in the CSI report.

Example Embodiment C28. The method of any one of Example Embodiments C1 to C26, comprising receiving, from the network node, a number of bits to be included in the CSI report.

Example Embodiment C29. The method of Example Embodiments C1 to C28, further comprising: providing user data; and forwarding the user data to a host via the transmission to the network node.

Example Embodiment C30. A user equipment comprising processing circuitry configured to perform any of the methods of Example Embodiments C1 to C29.

Example Embodiment C31. A wireless device comprising processing circuitry configured to perform any of the methods of Example Embodiments C1 to C29.

Example Embodiment C32. A computer program comprising instructions which when executed on a computer perform any of the methods of Example Embodiments C1 to C29.

Example Embodiment C33. A computer program product comprising computer program, the computer program comprising instructions which when executed on a computer perform any of the methods of Example Embodiments C1 to C29.

Example Embodiment C34.A non-transitory computer readable medium storing instructions which when executed by a computer perform any of the methods of Example Embodiments C1 to C29.

### Group D Example Embodiments

Example Embodiment D1. A method by a network node for receiving reported Channel State Information (CSI), the method comprising: receiving, from a user equipment (UE), a CSI report that comprises a plurality of parts, each of the plurality of parts being received on a respective one of a plurality of uplink control information (UCI) parts.

Example Embodiment D2. The method of Example Embodiment D1, further comprising configuring the UE to perform any of the steps and/or features recited in Example Embodiments C1 to C25.

Example Embodiment D3. The method of any one of Example Embodiments D1 to D2, comprising transmitting priority information to the UE, wherein the priority information indicates a plurality of priority levels to be assigned to bits and/or bit groups within CSI information.

Example Embodiment D4. The method of any one of Example Embodiments D1 to D3, wherein the CSI report is segmented into Part 1 CSI and Part 2 CSI.

Example Embodiment D5. The method of any one of Example Embodiments D1 to D3, wherein the CSI report includes Part 2 CSI but does not include Part 1 CSI.

Example Embodiment D6. The method of any one of Example Embodiments D1 to D3, wherein the CSI report is segmented into Part 1 CSI, Part 2 CSI, and Part 3 CSI, wherein the Part 3 CSI is for AI-CSI.

Example Embodiment D7. The method of any one of Example Embodiments D1 to D3, wherein the CSI report is segmented into Part 1 CSI and Part 3 CSI, wherein the Part 3 CSI is for AI-CSI.

Example Embodiment D8. The method of any one of Example Embodiments D1 to D3, wherein the CSI report includes Part 3 CSI but does not include Part 1 CSI or Part 2 CSI, and wherein the Part 3 CSI is for AI-CSI.

Example Embodiment D9. The method of any one of Example Embodiments D1 to D3, wherein the Part 3 CSI comprises a plurality of sub-parts.

Example Embodiment D10. The method of any one of Example Embodiments D1 to D3, wherein the Part 1 CSI, if included in the CSI report, includes at least one of: CRI, RI, CQI, and any information for decoding Part 2 CSI and/or Part 3 CSI.

Example Embodiment D11. The method of any one of Example Embodiments D1 to D3, wherein the Part 2 CSI, if included in the CSI report, includes at least one feature/CSI extracted from a AE-based processing step.

Example Embodiment D12. The method of any one of Example Embodiments D1 to D3, wherein the Part 3 CSI, if included in the CSI report, includes at least one feature/CSI extracted from a AE-based processing step.

Example Embodiment D13. The method of any one of Example Embodiments D1 to D3, wherein the CSI report includes a plurality of features/CSI extracted from a AE-based processing step, and the plurality of features/CSI are ordered based on a standardized ordering scheme.

Example Embodiment D14. The method of any one of Example Embodiments D1 to D3, wherein the CSI report includes a plurality of features/CSI extracted from a AE-based processing step, and the plurality of features/CSI are ordered based on an ordering scheme that is obtained through a joint training of an encoder and a decoder.

Example Embodiment D15. The method of any one of Example Embodiments D13 to D14, wherein the plurality of features/CSI extracted from the AE-based processing step comprises a bit sequence, the bit sequence being segmented into a plurality of parts, sub-parts, and/or groups.

Example Embodiment D16. The method of Example Embodiment D15, wherein the segmentation of the bit sequence is based on at least one of: a subset of nodes from an output layer of an AE; a Transmission layer; spatial domain information provided by the CSI; frequency domain information provided by the CSI; and time domain information provided by the CSI.

Example Embodiment D17. The method of any one of Example Embodiments D15 to D16, wherein the segmentation of the bit sequence is based on a priority function, and wherein the priority function depends on at least one of: a transmission layer index; a CSI-RS or antenna port index; a basis index of some kind (e.g., spatial/frequency/time domain basis); an AI/ML model index; a Node index of an AI/ML model; an index for the type of CSI report; and a CSI report index.

Example Embodiment D18. The method of any one of Example Embodiments D1 to D17, wherein a number of bits in the CSI report is known to the network node.

Example Embodiment D19. The method of any one of Example Embodiments D1 to D18, comprising transmitting, to the UE, a number of bits in the CSI report.

Example Embodiment D20. The method of any one of Example Embodiments D1 to D18, comprising receiving, from the UE, information indicating a number of bits to be included in the CSI report.

Example Embodiment D21. The method of any one of Example Embodiments D1 to D18, comprising determining a number of bits in the CSI report based on information in the CSI report.

Example Embodiment D22. The method of any one of Example Embodiments D1 to D21, wherein the network node comprises a gNodeB (gNB).

Example Embodiment D23. The method of any of the previous Example Embodiments, further comprising: obtaining user data; and forwarding the user data to a host or a user equipment.

Example Embodiment D24. A network node comprising processing circuitry configured to perform any of the methods of Example Embodiments D1 to D23.

Example Embodiment D25. A computer program comprising instructions which when executed on a computer perform any of the methods of Example Embodiments D1 to D23.

Example Embodiment D26. A computer program product comprising computer program, the computer program comprising instructions which when executed on a computer perform any of the methods of Example Embodiments D1 to D23.

Example Embodiment D27. A non-transitory computer readable medium storing instructions which when executed by a computer perform any of the methods of Example Embodiments D1 to D23.

### Group E Example Embodiments

Example Embodiment E1. A user equipment comprising: processing circuitry configured to perform any of the steps of any of the Group A and C Example Embodiments; and power supply circuitry configured to supply power to the processing circuitry.

Example Embodiment E2. A network node comprising: processing circuitry configured to perform any of the steps of any of the Group B and D Example Embodiments; power supply circuitry configured to supply power to the processing circuitry.

Example Embodiment E3. A user equipment (UE) comprising: an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A and C Example Embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Example Embodiment E4. A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to receive the user data from the host.

Example Embodiment E5. The host of the previous Example Embodiment, wherein the cellular network further includes a network node configured to communicate with the UE to transmit the user data to the UE from the host.

Example Embodiment E6. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E7. A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Example Embodiment E8. The method of the previous Example Embodiment, further comprising: at the host, executing a host application associated with a client application executing on the UE to receive the user data from the UE.

Example Embodiment E9. The method of the previous Example Embodiment, further comprising: at the host, transmitting input data to the client application executing on the UE, the input data being provided by executing the host application, wherein the user data is provided by the client application in response to the input data from the host application.

Example Embodiment E10.A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A and C Example Embodiments to transmit the user data to the host.

Example Embodiment E11. The host of the previous Example Embodiment, wherein the cellular network further includes a network node configured to communicate with the UE to transmit the user data from the UE to the host.

Example Embodiment E12. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E13.A method implemented by a host configured to operate in a communication system that further includes a network node and a user equipment (UE), the method comprising: at the host, receiving user data transmitted to the host via the network node by the UE, wherein the UE performs any of the steps of any of the Group A and C Example Embodiments to transmit the user data to the host.

Example Embodiment E14. The method of the previous Example Embodiment, further comprising: at the host, executing a host application associated with a client application executing on the UE to receive the user data from the UE.

Example Embodiment E15. The method of the previous Example Embodiment, further comprising: at the host, transmitting input data to the client application executing on the UE, the input data being provided by executing the host application, wherein the user data is provided by the client application in response to the input data from the host application.

Example Embodiment E16.A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B and D Example Embodiments to transmit the user data from the host to the UE.

Example Embodiment E17. The host of the previous Example Embodiment, wherein: the processing circuitry of the host is configured to execute a host application that provides the user data; and the UE comprises processing circuitry configured to execute a client application associated with the host application to receive the transmission of user data from the host.

Example Embodiment E18.A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B and D Example Embodiments to transmit the user data from the host to the UE.

Example Embodiment E19. The method of the previous Example Embodiment, further comprising, at the network node, transmitting the user data provided by the host for the UE.

Example Embodiment E20. The method of any of the previous 2 Example Embodiments, wherein the user data is provided at the host by executing a host application that interacts with a client application executing on the UE, the client application being associated with the host application.

Example Embodiment E21.A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B and D Example Embodiments to transmit the user data from the host to the UE.

Example Embodiment E22. The communication system of the previous Example Embodiment, further comprising: the network node; and/or the user equipment.

Example Embodiment E23.A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B and D Example Embodiments to receive the user data from a user equipment (UE) for the host.

Example Embodiment E24. The host of the previous 2 Example Embodiments, wherein: the processing circuitry of the host is configured to execute a host application, thereby providing the user data; and the host application is configured to interact with a client application executing on the UE, the client application being associated with the host application.

Example Embodiment E25. The host of the any of the previous 2 Example Embodiments, wherein the initiating receipt of the user data comprises requesting the user data.

Example Embodiment E26.A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B and D Example Embodiments to receive the user data from the UE for the host.

Example Embodiment E27. The method of the previous Example Embodiment, further comprising at the network node, transmitting the received user data to the host.

1.-38. (canceled)

39. A method by a user equipment, UE, for reporting Channel State Information, CSI, the method comprising:
obtaining CSI information; and
segmenting the CSI information into a plurality of parts, wherein the CSI information comprises a plurality of bits, a priority level is assigned to each bit and/or each bit group; and
the method comprises:
identifying, based on the priority level assigned to each bit and/or each bit group, at least one bit or at least one bit group for the plurality of parts;
transmitting, to a network node, an Artificial Intelligence-based, AI-based, CSI report that comprises the plurality of parts, each of the plurality of parts being transmitted on a respective one of a plurality of uplink control information, UCI, parts, wherein an interpretation of at least one bit of at least one of the plurality of parts is based on an output of a machine learning model.

40. The method of any claim 39, wherein segmenting the CSI information into the plurality of parts comprises segmenting the CSI information into at least two of:
Part 1 CSI,
Part 2 CSI, and
Part 3 CSI, and
wherein Part 1 CSI comprises information for decoding at least one of Part 2 CSI and Part 3 CSI, wherein at least one of the Part 2 CSI and the Part 3 CSI comprises CSI determined using the machine learning model.

41. The method of claim 40, comprising:
determining that an allocated size of the UCI is less than a size of the obtained CSI information, and
based on at least one omission rule, identifying at least one of the plurality of parts to be omitted from the AI-based CSI report.

42. The method of claim 40, wherein the transmitted AI-based CSI report includes at least one of the Part 2 CSI and Part 3 CSI but the Part 1 CSI is omitted.

43. The method of claim 40, wherein the transmitted AI-based CSI report includes the Part 1 CSI and the Part 3 CSI but the Part 2 CSI is omitted, and wherein an interpretation of at least one bit of the Part 3 CSI is based on an output of the machine learning model.

44. The method of claim 40 wherein at least one of the Part 1 CSI, the Part 2 CSI, and the Part 3 CSI comprises a plurality of features extracted using the machine learning model, and wherein the method further comprises ordering the plurality of features based on an ordering scheme.

45. The method of claim 39, comprising transmitting, to the network node, or receiving, from the network node, an indication of a number of bits to be included the CSI report.

46. A method by a network node for receiving reported Channel State Information, CSI, the method comprising:
receiving, from a user equipment, UE, an Artificial Intelligence-based, AI-based, CSI report that comprises a plurality of parts, each of the plurality of parts being received on a respective one of a plurality of uplink control information, UCI, parts, wherein an interpretation of at least one bit of at least one of the plurality of parts is based on an output of a machine learning model, and
using the machine learning model to interpret the at least one bit of the at least one of the plurality of parts.

47. The method of claim 46, comprising configuring the UE to segment CSI information obtained by the UE into the plurality of parts, and transmitting priority information to the UE, wherein the priority information indicates a plurality of priority levels to be assigned to bits and/or bit groups within CSI information obtained by the UE.

48. The method of claim 46, wherein the CSI report is segmented into at least two of:
Part 1 CSI,
Part 2 CSI, and
Part 3 CSI, and
wherein Part 1 CSI comprises information for decoding at least one of Part 2 CSI and Part 3 CSI.

49. The method of claim 46, comprising transmitting, to the UE, or
receiving, from the UE, an indication of a number of bits to be included the CSI report.

50. A user equipment, UE, for reporting Channel State Information, CSI, the UE adapted to:
obtain CSI information; and
segment the CSI information into a plurality of parts, wherein the CSI information comprises a plurality of bits, a priority level is assigned to each bit and/or each bit group;
identify, based on the priority level assigned to each bit and/or each bit group, at least one bit or at least one bit group for the plurality of parts;
transmit, to a network node, an Artificial Intelligence-based, AI-based, CSI report that comprises the plurality of parts, each of the plurality of parts being transmitted on a respective one of a plurality of uplink control information, UCI, parts, wherein an interpretation of at least one bit of at least one of the plurality of parts is based on an output of a machine learning model.

51. The UE of claim 50, wherein the UE adapted to wherein segment the CSI information into the plurality of parts comprises the UE adapted to segment the CSI information into at least two of
Part 1 CSI,
Part 2 CSI, and
Part 3 CSI, and
wherein Part 1 CSI comprises information for decoding at least one of Part 2 CSI and Part 3 CSI, wherein at least one of the Part 2 CSI and the Part 3 CSI comprises CSI determined using the machine learning model.

52. A network node for receiving reported Channel State Information, CSI, the network node adapted to:
receive from a user equipment, UE, an Artificial Intelligence-based, AI-based, CSI report that comprises a plurality of parts, each of the plurality of parts being received on a respective one of a plurality of uplink control information, UCI, parts, wherein an interpretation of at least one bit of at least one of the plurality of parts is based on an output of a machine learning model,
use the machine learning model to interpret the at least one bit of the at least one of the plurality of parts.

53. The network node of claim 52, wherein the CSI report is segmented into at least two of
Part 1 CSI,
Part 2 CSI, and
Part 3 CSI, and
wherein Part 1 CSI comprises information for decoding at least one of Part 2 CSI and Part 3 CSI.
